(19) United States
(12) Patent Application Publication
(10) Pub. No.: US 2025/0361334 A1
(43) Pub. Date: Nov. 27, 2025

(54) PROCESS FOR PREPARING AN AQUEOUS POLYMER DISPERSION

(71) Applicant: BASF SE, Ludwigshafen am Rhein (DE)

(72) Inventors: Martin Robert SCHEUBLE, Ludwigshafen am Rhein (DE); Bastiaan LOHMEIJER, Ludwigshafen am Rhein (DE); Konrad ROSCHMANN, Ludwigshafen am Rhein (DE); Oliver WAGNER, Ludwigshafen am Rhein (DE); Felix LAUTERBACH, Ludwigshafen am Rhein (DE)

(21) Appl. No.: 18/858,413

(22) PCT Filed: Apr. 21, 2023
(86) PCT No.: PCT/EP2023/060418

§ 371 Date: Oct. 21, 2024

(30) Foreign Application Priority Data
Apr. 22, 2022 (EP) 22169507.5

(51) Int. Cl. C08F 6/24

(52) U.S. Cl. CPC C08F 6/24

(57) ABSTRACT

The present invention relates to processes for preparing an aqueous polymer dispersion, aqueous polymer dispersions and a use of said dispersions in aqueous formulations for coatings, sealants and adhesive bonding. Further, the present invention relates to aqueous formulations for coatings, sealants and adhesive bonding comprising said dispersions and a process for preparing said aqueous formulations.

The present invention relates to processes for preparing an aqueous polymer dispersion, aqueous polymer dispersions and a use of said dispersions in an aqueous formulation for coatings, sealants, and adhesive bonding. Further, the present invention relates to an aqueous formulation for coatings, sealants, and adhesive bonding comprising said dispersion and a process for preparing said aqueous formulation.

Aqueous polymer dispersions are frequently used as binders in polymer bound coating compositions. Polymer bound coating compositions can be formulated at pigment volume concentrations (PVC) below the critical pigment volume concentration (cPVC) or above. The pigment volume concentration is the mathematical ratio of the volume fraction of pigment and fillers to the total volume of the dried coatings. The critical pigment volume concentration is the PVC at which the polymer binder in the dried coating still completely wets the pigments and fillers contained in the coating composition and fills all the interstices. Accordingly, if the coating composition is formulated at a PVC below the cPVC, the coating is just coherent and continuous while above the cPVC the binder only provides bridges between the pigment and filler particles and the paint film develops open pores and voids.

One of the very basic properties of coating compositions is the amount that can be applied onto the surface to be coated. It is apparent, that for a coating composition which is formulated below the cPVC, the dry layer thickness is the straightforward result of the solids content and the density of the paint after complete drying, while in a coating composition formulated above the cPVC, the air void volume needs to be considered. The higher the solids content, all else being equal, the higher the dry layer thickness. High dry layer thicknesses have advantages in increased hiding per coating step allowing a reduction in the number of coating steps. Aqueous polymer dispersions in general provide—compared to polymers prepared in solution—significant benefits during the polymerization process like low viscosity despite high molecular weight and excellent heat removal through the water phase. However, the use of these water-based dispersions in coating composition like paints or clear coats also introduces a significant amount of water into the system which prevents on the one hand the formulation of paints with high solid content and on the other hand limits the freedom of the formulator to choose the moment in which the water is added during the formulation process. This becomes particularly evident in a modern modular paint factory as opposed to more traditional ways of paint manufacture for waterborne coatings (Farbe und Lack, Die Modulare Lackfabrik im Kleinformat, December 2011, pages 14-17, Vincentz). Instead of stepwise adding solids like e.g. pigments, fillers and matting agents that need to be wetted, dispersed and homogenized, in a modular approach premanufactured slurries of such components (stored in different tanks) are combined. This gives rise to higher production flexibility, shorter production times, lower energy use and reduced overall costs for the manufacturer. A downside is that more water is needed to pre-manufacture slurries as well as for flushing the equipment, ultimately lowering the maximum achievable solids content of the paint.

The majority of polymer dispersions used in the decorative coating industry include polymers with solid contents of around 50 wt %, more specifically<55 wt.-%, with a few exceptions in e.g. elastomeric coatings. Each % of solid content of the dispersion enhances the freedom of the formulator which is a particular challenge in modern modular paint factories. Polymer dispersions with solid contents>50 wt.-% are therefore desired.

Inherently, high solid dispersions lower the CO₂ footprint during transportation: Since water can be—if for the preparation or application properties of the paint needed—easily sourced locally, the reduction of the water content leads to a reduced amount of shipped dispersion per kg polymer in dry state and thus to reduced CO₂ emissions due to transportation.

Emulsion polymerization with monomodal particle sizes and final solid content of >60 wt.-% result in dispersions with high viscosities and high amounts of (fine) coagulum. Therefore, an optimized particle size distribution is needed which enables the efficient use of the available space in the dispersion. Bimodal or multimodal particle size distributions are therefore proposed in the literature. For example, EP 1 302 515 A2 discloses a bimodal emulsion copolymer used in aqueous coatings. The bimodality is either achieved by mixing two latexes or by a method, where the pH is altered during the polymerization. However, the solids content is also below 55 wt.-%. Copolymer emulsions with bimodal particle size distribution (and solid contents around 50 wt.-%) are also discussed in “Study of Poly(St/BA/MAA) Copolymer Latexes with Bimodal Particle Size Distribution”, Fuxiang Chu et al., Polym. Adv. Technol. 9, 851-857 (1998).

U.S. Pat. No. 5,726,259 describes a process for preparing high solid content dispersions by a complex sequential emulsion polymerization comprising the in-situ preparation of a seed latex followed by sequential emulsion polymerization, where the monomers are sequentially fed to the reaction zone at a rate which exceeds the rate of consumption, further followed by the in-situ formation of a second seed latex in the presence of the non-reacted monomers of the first sequential polymerization, further followed by a second sequential polymerization. These latexes are suggested for the use in paper coatings but are not suitable for the applications described herein.

In another approach, WO 1998/16560 describes the preparation of dispersions with high solids contents and bimodal particle size distributions induced by a change in pH during polymerization; yet, their final particle sizes are out of the ranges required for the applications described herein. In WO 2001/38412 another method is claimed for preparing multimodal particle size distributions at high solid contents via a pH change during the polymerization. However, it is not discussed how the process affects coagulum values which can be a decisive factor in the final application.

Since properties like e.g. coagulum content or viscosity are strongly influenced also by small deviations in the particle size distribution the reproducibility of the process is very crucial. Therefore, seeded processes in combination with a seed induced generation of a second particle generation is to be favored above processes where the initial particles are generated via an in-situ process and/or the second generation is generated via addition of an excess of soap during the emulsion polymerization or a sudden pH change.

Therefore, there is a need to provide improved, highly efficient processes for preparing an aqueous polymer dispersion which exhibits high solid content, low coagulum, and moderate/adequate viscosity to provide good coating properties such as improved opacity, fast drying, good paint-feel, when used as a binder in paints and clear coats. It was surprisingly found that the processes for preparing an aqueous polymer dispersion according to the present invention permits to achieve such objectives. Further, the claimed invention also permits to reduce CO₂-footprint and increase freedom of the formulator.

### I. Process for Preparing an Aqueous Polymer Dispersion

Therefore, the present invention relates to a process for preparing an aqueous polymer dispersion having a polymer content of at least 50 weight-% based on the total weight of the aqueous polymer dispersion, the process comprising
(i) preparing a first aqueous mixture X(1) comprising water and a first base,
(ii) preparing a second aqueous mixture X(2) comprising water, ethylenically unsaturated monomers which exhibit a Bronsted acidic group, ethylenically unsaturated monomers which do not exhibit a Bronsted acidic group and a second base;
(iii) introducing the first aqueous mixture X(1) according to (i) into a polymerization vessel;
(iv) introducing the second aqueous mixture X(2) into the polymerization vessel comprising the first aqueous mixture X(1) according to (i) and subjecting to copolymerization, obtaining said aqueous polymer dispersion;
   wherein the polymer particles of the aqueous polymer dispersion obtained according to (iv) exhibit a polymodal particle size distribution;
   wherein at least 95 weight-% of the polymers comprised in the aqueous polymer dispersion are based on the monomers employed according to (ii) and (iv).

### First Aqueous Mixture X(1)—Pre-Charge

Preferably the first base comprised in the first aqueous mixture X(1) comprises an anionic group and a counterion, the anionic group being selected from the group consisting of HCO₃⁻, P₂O₇⁴⁻, CH₃COO⁻, HPO₄²⁻, H₂PO₄⁻, C₃H₅O₃⁻ (propionate), C₆H₅O₇³⁻ (citrate) and CO₃²⁻, more preferably selected from the group consisting of HCO₃⁻ and P₂O₇⁴⁻, more preferably is HCO₃⁻ or P₂O₇⁴⁻. Preferably the counterion comprised in the first base comprised in the first aqueous mixture X(1) is selected from the group consisting of Na⁺, K⁺, NH₄⁺ and Li⁺, more preferably selected from the group consisting of Na⁺ and NH₄⁺.

Preferably wherein the first base comprised in the first aqueous mixture X(1) is selected from the group consisting of NaHCO₃, Na₄P₂O₇ and NH₄HCO₃.

Preferably the first aqueous mixture X(1) prepared according to (i) further comprises a seed latex, wherein the seed latex is an aqueous polymer dispersion having a polymer content in the range of from 20 to 50 weight-%, more preferably in the range of from 25 to 42 weight-%, based on the total weight of the seed latex. More preferably the polymer particles of the seed latex exhibit a monomodal particle size distribution.

Preferably the polymer particles of the seed latex have an average diameter in the range of from 10 to 100 nm, more preferably in the range of from 15 to 80 nm, more preferably in the range of from 20 to 40 nm, being determined as described in Reference Example 1.2.

Preferably the polymer of the seed latex is selected from the group consisting of polystyrene, styrene-acrylate copolymer, polyacrylate and a mixture of two or more thereof, more preferably is selected from the group consisting of polystyrene and styrene-acrylate copolymer, more preferably is polystyrene or styrene-acrylate copolymer.

Preferably, (i) comprises
(i.1) admixing water and a first base under an inert gas atmosphere;
(i.2) admixing a seed latex as defined in the foregoing to the mixture obtained according to (i.1);
(i.3) heating the mixture obtained according to (i.2) to a temperature in the range of from 70 to 100° C., more preferably in the range of from 80 to 90° C., more preferably while stirring;
   wherein (i) more preferably consists of (i.1) and (i.2) and (i.3).

As to admixing according to (i.1), it is preferred that it is performed at a temperature in the range of from 15 to 35° C., more preferably in the range of from 18 to 30° C., more preferably in the range of from 20 to 25° C. In other words, it is preferred that admixing according to (i.1) is performed at room temperature. It is however noted that admixing according to (i.2) can preferably be performed at higher temperature. The skilled person would know how to choose the adequate temperature for (i.1).

As to admixing according to (i.2), it is preferred that it is performed at a temperature in the range of from 15 to 35° C., more preferably in the range of from 18 to 30° C., more preferably in the range of from 20 to 25° C. In other words, it is preferred that admixing according to (i.2) is performed at room temperature.

It is however noted that admixing according to (i.1) and/or (i.2) can also be performed at higher temperature. The skilled person would know how to choose the adequate temperature for each of (i.1) and (i.2).

Preferably the inert gas atmosphere is a nitrogen gas atmosphere.

### Second Aqueous Mixture X(2)

Monomers which Exhibit a Bronsted Acidic Group

Preferably the ethylenically unsaturated monomers which exhibit a Bronsted acidic group comprised in the second aqueous mixture X(2) prepared according to (ii) are selected from the group consisting of monoethylenically unsaturated monocarboxylic acids having 3 to 6 carbon atoms, monoethylenically unsaturated dicarboxylic acids having 4 to 6 carbon atoms, monoethylenically unsaturated sulfonic acids, monoethylenically unsaturated phosphonic acids, monoethylenically unsaturated phosphoric acids and a mixture of two or more thereof.

More preferably the ethylenically unsaturated monomers which exhibit a Bronsted acidic group comprised in the second aqueous mixture X(2) prepared according to (ii) are:
monoethylenically unsaturated monocarboxylic acids having 3 to 6 carbon atoms; or
monoethylenically unsaturated monocarboxylic acids having 3 to 6 carbon atoms and monoethylenically unsaturated sulfonic acids.

Preferably the total amount of monomers which exhibit a Bronsted acidic group comprised in the second aqueous mixture X(2) prepared according to (ii) is in the range of from 0.5 to 5 pphm, more preferably in the range of from 1 to 3 pphm, based on the total amount of monomers comprised in the second aqueous mixture X(2). Here, “pphm” refers to parts per hundred monomers, this permits to evaluate the amount of the monomers, which exhibit a Bronsted acidic group comprised in the second aqueous mixture X(2) prepared according to (ii), in the second mixture X(2) relative to 100 parts of the monomers forming the second aqueous mixture X(2).

As to the monoethylenically unsaturated monocarboxylic acid having 3 to 6 carbon atoms, it is preferred that it is one or more of methacrylic acid, acrylic acid, crotonic acid, 2-ethylpropenoic acid, 2-propylpropenoic acid, 2-acryloxyacetic acid and 2-methacyloxyacetic acid, more preferably one or more of methacrylic acid and acrylic acid, more preferably methacrylic acid or acrylic acid.

As to the monoethylenically unsaturated dicarboxylic acid having 4 to 6 carbon atoms, it is preferred that it is one or more of itaconic acid, maleic acid and fumaric acid.

As to the monoethylenically unsaturated sulfonic acid, it is preferred that it is one or more of 2-acrylamido-2-methylpropane sulfonic acid (AMPS), vinylsulfonic acid, allylsulfonic acid, sulfoethyl methacrylate, sulfopropyl methacrylate and styrenesulfonic acid, more preferably one or more of AMPS and vinylsulfonic acid more preferably AMPS.

As to the monoethylenically unsaturated phosphonic acid, it is preferred that it is one or more of vinylphosphonic acid, allylphosphonic acid, styrenephosphonic acid and 2-acrylamido-2-methylpropane phosphonic acid, more preferably vinylphosphonic acid.

As to the monoethylenically unsaturated phosphoric acids, it is preferred that it is one or more of monophosphates of hydroxyalkyl acrylates, monophosphates of hydroxyalkyl methacrylates, monophosphates of alkoxylated hydroxyalkyl acrylates and monophosphates of alkoxylated hydroxyalkyl methacrylates, more preferably one or more of monophosphates of hydroxyethyl acrylate, hydroxypropyl acrylate or hydroxybutyl acrylate, monophosphates of hydroxyethyl methacrylate, hydroxypropyl methacrylate or hydroxybutyl methacrylate, monophosphates of ethoxylated hydroxy-C2-C4-alkyl acrylates, monophosphates of propoxylated hydroxy-C2-C4-alkyl acrylates, monophosphates of ethoxylated hydroxy-C2-C4-alkyl methacrylates and monophosphates of propoxylated hydroxy-C2-C4-alkyl methacrylates, more preferably one or more of monophosphates of hydroxyethyl methacrylate, monophosphates of ethoxylated hydroxy-C2-C4-alkyl methacrylates and monophosphates of propoxylated hydroxy-C2-C4-alkyl methacrylates.

In the context of the present invention, the aforementioned monomers can be present in their acidic form or in the form of their salts, preferably in the form of their alkali metal salts or ammonium salts.

As to preferred different aspects of the present invention, it is more preferred that the ethylenically unsaturated monomers which exhibit a Bronsted acidic group comprised in the second aqueous mixture X(2) prepared according to (ii) are
methacrylic acids; or
acrylic acids; or
methacrylic acids and 2-acrylamido-2-methylpropane sulfonic acid (AMPS); or
acrylic acids and 2-acrylamido-2-methylpropane sulfonic acid (AMPS).
   Monomers which do not Exhibit a Bronsted Acidic Group

Preferably the monomers which do not exhibit a Bronsted acidic group comprised in the second aqueous mixture X(2) prepared according to (ii) comprises one or more of C₁-C₂₀ alkyl esters of acrylic acid, C₁-C₂₀ alkyl esters of methacrylic acid, C₅-C₂₀ cycloalkyl esters of acrylic acid, C₅-C₂₀ cycloalkyl esters of methacrylic acid, C₅-C₂₀ cycloalkylmethyl esters of acrylic acid, C₅-C₂₀ cycloalkylmethyl esters of methacrylic acid, wherein the cycloalkyl in the aforementioned monomers is mono-, bi- or tricyclic and wherein 1 or 2 nonadjacent CH₂ moieties of the cycloalkyl may be replaced by oxygen atoms and wherein the cycloalkyl may be unsubstituted or carry 1, 2, 3 or 4 methyl groups, and vinylaromatic monomers. More preferably the monomers which do not exhibit a Bronsted acidic group comprised in the aqueous monomer mixture used in (ii) comprises C₁-C₂₀ alkyl esters of acrylic acid and vinylaromatic monomers.

As to the C₁-C₂₀ alkyl ester of acrylic acid, it is preferred that it is selected from the group consisting of methyl acrylate, ethyl acrylate, n-propyl acrylate, isopropyl-acrylate, n-butyl acrylate, 2-butyl acrylate, isobutyl acrylate, tert-butyl acrylate, n-pentyl acrylate, isoamyl acrylate, n-hexyl acrylate, n-octyl acrylate, 2-octyl acrylate, 2-ethylhexyl acrylate, n-decyl acrylate, 2-propylheptyl acrylate, lauryl acrylate, C₁₂/C₁₄-alkyl acrylate, and a mixture of two or more thereof, preferably selected from the group consisting of n-butyl acrylate, iso-butyl acrylate, tert-butyl acrylate, 2-octyl acrylate, 2-ethylhexyl acrylate, and a mixture of two or more thereof, more preferably is selected from the group consisting of n-butyl acrylate, 2-ethylhexyl acrylate and a mixture thereof.

As to the monomers which do not exhibit a Bronsted acidic group comprised in the second aqueous mixture X(2) prepared according to (ii), it is more preferred that it comprises
styrene and n-butyl acrylate; or
styrene, n-butyl acrylate and 2-ethylhexyl acrylate.

Preferably the total amount of C₁-C₂₀ alkyl esters of acrylic acid in the second mixture X(2) is in the range of from 20 to 80 pphm, more preferably in the range of from 30 to 65 pphm, more preferably in the range of from 40 to 60 pphm, based on the total amount of monomers comprised in the second aqueous mixture X(2). Here, “pphm” refers to parts per hundred monomers, this permits to evaluate the amount of the monomers, namely the C₁-C₂₀ alkyl esters of acrylic acid in the second aqueous mixture X(2) prepared according to (ii), in the second mixture X(2) relative to 100 parts of the monomers forming the second aqueous mixture X(2).

As to the vinylaromatic monomer, it is preferred that it is a mono-vinyl substituted aromatic hydrocarbons selected from the group consisting of styrene, 2-methylstyrene, 4-methylstyrene, 2-n-butylstyrene, 4-n-butylstyrene, 4-n-decylstyrene, α-methylstyrene and a mixture of two or more thereof, more preferably selected from the group consisting of styrene, 4-methylstyrene and α-methylstyrene, more preferably styrene.

Preferably the total amount of the vinylaromatic monomers in the mixture X(2) is in the range of 30 to 69.5 pphm, more preferably in the range of from 35 to 59 pphm based on the total amount of monomers comprised in the second aqueous mixture X(2). Here, “pphm” refers to parts per hundred monomers, this permits to evaluate the amount of the monomers, namely the vinylaromatic monomers in the second aqueous mixture X(2) prepared according to (ii), in the second mixture X(2) relative to 100 parts of the monomers forming the second aqueous mixture X(2).

Preferably, in the second aqueous mixture X(2) prepared according to (ii), the degree of neutralization of the monomers which exhibit a Bronsted acidic group is in the range of from 5 to 250%, more preferably in the range of from 10 to 200%, more preferably in the range of from 15 to 150%, the degree of neutralization being determined by the molar ratio of the amount of base to the amount of carboxylic acid functionalities.

Preferably, in the second aqueous mixture X(2) prepared according to (ii), the molar ratio of the second base to the Bronsted acidic group of the monomers which exhibit a Bronsted acidic group is in the range of from 0.05:1 to 2.5:1, more preferably in the range of from 0.10:1 to 2:1, more preferably in the range of from 0.15:1 to 1.5:1.

Preferably Tg(X(2)) is in the range of from −10 to 40° C., more preferably in the range of from −5 to 30° C., more preferably in the range of from −5 to 9° C., more preferably in the range of from 0 to 8° C., or more preferably in the range of from 10 to 30° C., more preferably in the range of from 12 to 25° C., Tg(X(2)) being the theoretical glass transition temperature (Tg) of the polymer which would be obtained from polymerization of the monomers of the mixture X(2), wherein said theoretical glass transition temperatures Tg(X(2)) is determined according to the Fox equation.

Preferably the second base comprised in the second aqueous mixture X(2) prepared according to (ii) is selected from the group consisting of sodium hydroxide, ammonium hydroxide, sodium carbonate, ammonium bicarbonate, potassium hydroxide, calcium hydroxide, sodium bicarbonate, more preferably is selected from the group consisting of sodium hydroxide, ammonium hydroxide and potassium hydroxide, more preferably is sodium hydroxide.

### Further Monomers

Preferably the second aqueous mixture X(2) prepared according to (ii) may further comprise monoethylenically unsaturated silane functional monomers. Said monoethylenically unsaturated silane functional monomers are preferably monomers which in addition to an ethylenically unsaturated double bond bear at least one mono-, di- and/or tri-C1-C4-alkoxysilane group. Preferred monoethylenically unsaturated silane functional monomer are one or more of vinyl triethoxysilane (VTEO), 3-methacryloxypropyl trimethoxysilane (MEMO), vinyl trimethoxysilane, methacryloxymethyl trimethoxysilane and methacryloxymethyl triethoxysilane.

More preferably the second aqueous mixture X(2) prepared according to (ii) may further comprise one or more of vinyl triethoxysilane (VTEO), 3-methacryloxypropyl trimethoxysilane (MEMO), more preferably VTEO or MEMO.

As to preferred aspects of the present invention, it is more preferred that the second aqueous mixture X(2) prepared according to (ii) comprises
methacrylic acids as the ethylenically unsaturated monomers which exhibit a Bronsted acidic group and MEMO or VTEO as the silane monomers; or
acrylic acids as the ethylenically unsaturated monomers which exhibit a Bronsted acidic group and MEMO or VTEO as the silane monomer; or
methacrylic acids, 2-acrylamido-2-methylpropane sulfonic acid (AMPS) and MEMO or VTEO as the silane monomers; or
acrylic acids, 2-acrylamido-2-methylpropane sulfonic acid (AMPS) and MEMO or VTEO as the silane monomers.

### Other Components

Preferably the second aqueous mixture X(2) further comprises one or more surfactants, wherein the surfactants are each selected from the group consisting of an anionic surfactant, a non-ionic surfactant and a mixture thereof.

As to the anionic surfactant, it is preferred that it comprises at least one anionic group, which is more preferably selected from the group consisting of a phosphate group, a phosphonate group, a sulfate group and a sulfonate group.

Preferably from 0 to 5 weight-%, more preferably from 0.1 to 3 weight-%, more preferably from 0.2 to 2 weight-%, of the the second aqueous mixture X(2) consist of the one or more surfactants.

Preferably the surfactant is an anionic surfactant, being more preferably an anionic emulsifier comprising at least one a sulfate group or a sulfonate group, more preferably a sulfate group.

Preferably the anionic emulsifier comprising a sulfate group is a salt of alkyl sulfates or alkyl ether sulfates, more preferably C8-C22-alkyl sulfates or C8-C22 alkyl ether sulfates.

For example, the emulsifier can preferably be at least one anionic copolymerizable emulsifier, being more preferably selected from the group consisting of

### (1) a Compound of Formula (I)

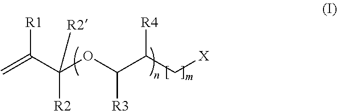

wherein R1 is H, alkyl, cycloalkyl, aralkyl, aryl, or alkoxyaryl, R2, R2′ is —H or R2 and R2′ are O, R3 is H or alkyl, R4 is H or OH, X is SO₃⁻, SO₄⁻, HPO₄⁻, PO₄²⁻, or COO⁻, m is 0 or 1, and n is an integer in the range of from 1 to 1000, more preferably in the range of from 1 to 500, more preferably in the range of from 4 to 50;

### (2) a Compound of Formula (II)

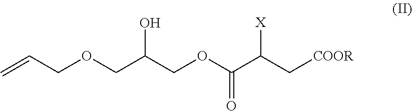

wherein X is SO₃⁻, PO₄²⁻, or SO₄⁻, and R is H, alkyl cycloalkyl, aralkyl, aryl or alkoxyaryl; (3) a compound of formula (IIIa) or (IIIb)

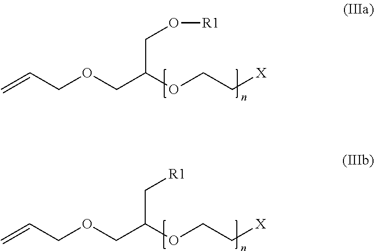

wherein R1 is H, alkyl, cycloalkyl, aralkyl aryl or alkoxyaryl, X is SO₄⁻, SO₃⁻, HPO₄⁻, PO₄²⁻, or COO⁻, n is an integer in the range of from 1 to 1000, more preferably in the range of from 1 to 500, most preferably in the range of from 4 to 50;

### (4) a Compound of the Formula (IV)

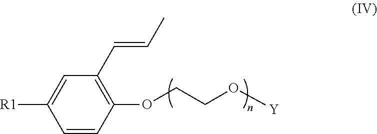

wherein R1 is H, alkyl, cycloalkyl, aralkyl, aryl, or alkoxyaryl, Y is SO₃⁻, PHO₃⁻, or PO₃²⁻, and n is an integer in the range of from 1 to 1000, more preferably in the range of from 1 to 500, more preferably in the range of from 4 to 50;
or mixtures of the compounds of the formulae (I) to (IV).

The anionic copolymerizable emulsifiers may be present in neutralized form. The counterion present for the anionic groups X and/or Y can preferably be a cation selected from the group consisting of Li⁺, Na⁺, K⁺, Ca₂⁺, NH₄⁺, and mixtures thereof, more preferably NH₄⁺ or Na⁺.

A non-exhaustive list of suitable anionic copolymerizable emulsifiers comprises Adeka Reasoap SR-10, SR-1025, SR-20 and SR-3025 (compounds of formula IIIa), Adeka Reasoap SE-10N, SE-1025A and SE-20N (compounds of formula IIIa), Hitenol KH-05, KH-0530, KH-10 and KH1025 (compounds of formula IIIb) and Hitenol BC-10, BC-1025, BC-20, BC-2020 and BC-30 (compounds of formula IV). Furthermore, the surfactants disclosed in paragraphs 65-74 of EP 3 452 523 B1 are also suitable.

Preferably the second aqueous mixture X(2) is an emulsion.

Preferably the second aqueous mixture X(2) comprises water, the ethylenically unsaturated monomers which exhibit a Bronsted acidic group, the ethylenically unsaturated monomers which do not exhibit a Bronsted acidic group, the second base and more preferably one or more surfactants as defined in the foregoing.

Preferably from 98 to 100 weight-%, more preferably from 99 to 100 weight-%, more preferably from 99.5 to 100 weight-%, more preferably from 99.9 to 100 weight-%, of the second aqueous mixture X(2) consist of water, the ethylenically unsaturated monomers which exhibit a Bronsted acidic group, the ethylenically unsaturated monomers which do not exhibit a Bronsted acidic group, the second base and one or more surfactants as defined in the foregoing.

### Third Aqueous Mixture X(3)—Initiator

Preferably the process of the present invention further comprises introducing a third aqueous mixture X(3) into the polymerization vessel comprising the first aqueous mixture X(1), wherein the third aqueous mixture X(3) comprises water and an initiator.

Suitable initiators may be free-radical polymerization initiator (free-radical initiator). These may in principle be peroxides or azo compounds. Redox initiator systems can also be useful. The peroxides may in principle be inorganic peroxides, such as hydrogen peroxide or peroxodisulfates, such as the mono- or di-alkali metal or ammonium salts of peroxodisulfuric acid, for example the mono- and disodium, -potassium or ammonium salts, or organic peroxides, such as alkyl hydroperoxides, for example tert-butyl hydroperoxide, p-menthyl hydroperoxide or cumyl hydroperoxide, and also dialkyl or diaryl peroxides, such as di-tert-butyl or di-cumyl peroxide. Azo compounds can be 2,2′-azobis(isobutyronitrile), 2,2′-azobis(2,4-dimethyl-valeronitrile) and 2,2 azobis(amidinopropyl)dihydrochloride (AIBA, corresponds to V-50 from WakoChemicals). Furthermore, suitable oxidizing agents for redox initiator systems can be the peroxides specified above. Corresponding reducing agents which may be used are sulfur compounds with a low oxidation state, such as alkali metal sulfites, for example potassium and/or sodium sulfite, alkali metal hydrogen sulfites, for example potassium and/or sodium hydrogen sulfite, alkali metal metabisulfites, for example potassium and/or sodium metabisulfite, formaldehyde sulfoxylates, for example potassium and/or sodium formaldehyde sulfoxylate, alkali metal salts, specifically potassium and/or sodium salts of aliphatic sulfinic acids and alkali metal hydrogen sulfides, for example potassium and/or sodium hydrogen sulfide, salts of polyvalent metals, such as iron (II) sulfate, iron (II) ammonium sulfate, iron (II) phosphate, ene diols, such as dihydroxymaleic acid, benzoin and/or ascorbic acid, and reducing saccharides, such as sorbose, glucose, fructose and/or dihydroxyacetone.

Preferably the initiator is a free-radical initiator, being more preferably inorganic peroxide, more preferably peroxodisulfate salt, more preferably sodium peroxodisulfate.

Preferably the amount of the initiator comprised in the third aqueous mixture X(3) is in the range of from 0.1 to 1 weight-%, more preferably in the range of from 0.25 to 0.90 weight-%, based on the total amount of monomers comprised in the second aqueous mixture X(2).

### Feeds

Preferably, according to (iv), the second aqueous mixture X(2) is introduced continuously into the polymerization vessel as a first feed.

Preferably the first feed is introduced continuously at a constant feed rate.

Alternatively, the first feed is preferably introduced into the polymerization vessel according to (iv) at different feed rates, F1-Fx, with x=2 or more, wherein F1<Fx, wherein the feed rates are >0 g/h.

Preferably introducing the second aqueous mixture X(2) into the polymerization vessel according to (iv) is performed for a period in the range of from 90 to 350 minutes, more preferably in the range of from 100 to 320 minutes.

Preferably the third aqueous mixture X(3) is introduced continuously into the polymerization vessel as a second feed.

Preferably the second feed (initiator) is introduced into the polymerization vessel at different feed rates, F1-Fx, with x=2 or more, preferably 2, in g/h, wherein the feed rates are >0 g/h, wherein F1<Fx.

Preferably introducing the third aqueous mixture X(3) into the polymerization vessel is performed for a period in the range of from 150 to 400 minutes, more preferably in the range of from 175 to 330 minutes.

Preferably introducing the second aqueous mixture X(2) according to (iv) is performed at a time T(m) and introducing the third aqueous mixture X(3) as defined in the foregoing is performed at a time T(i), wherein T(m)≤T(i), preferably T(m)+3 min≤T(i), more preferably T(m)+5 min≤ T(i).

Preferably co-polymerization into the polymerization vessel according (iv) is conducted at a temperature in the range of from 70 to 100° C., more preferably in the range of from 80 to 90° C.

Preferably the process of the present invention further comprises introducing a seed latex, more preferably polystyrene, at a time T(s) into the polymerization vessel, wherein T(s) starts when at least 5 weight-%, more preferably at least 10 weight-%, more preferably at least 15 weight-%, more preferably from 15 to 70 weight-%, more preferably from 20 to 60 weight-%, of the aqueous mixture X(2) have been introduced into the polymerization vessel. Without wanting to be bound to any theory, it is believed that the addition of the seed latex at a time T(s) into the polymerization vessel permits to trigger the change in particle distribution of the polymer of the final dispersion, namely the aqueous polymer dispersion according to the present invention. Such step would then permit to control said change.

It is however noted that the change of the particle size distribution of the polymer of the final dispersion, namely the aqueous polymer dispersion according to the present invention, will also occur when no seed latex is added. The skilled person will however have less control of the time at which the change will be triggered. Thus, it is also preferred that no seed latex is further introduced in the polymerization vessel comprising the second aqueous mixture X(2).

Preferably the process of the present invention further comprises introducing a surfactant, preferably as defined in the foregoing, at a time T(e) into the polymerization vessel, wherein T(e) starts when at least 2 weight-%, more preferably at least 3 weight-%, more preferably from 3 to 60 weight-%, more preferably from 3 to 10 weight-% or more preferably from 40 to 60 weight-%, of the aqueous mixture X(2) have been introduced into the polymerization vessel. Without wanting to be bound to any theory, it is believed that said addition of surfactant at a time T(e) will permit to obtain the same results as with the addition of seed latex at a time T(s). This addition can thus be used as an alternative.

Preferably from 95 to 100 weight-%, more preferably from 98 to 100 weight-%, of the polymers comprised in the aqueous polymer dispersion are based on the monomers employed according to (ii) and (iv).

Preferably, the process of the present invention further comprises
(v) introducing water and one or more additives into the polymerization vessel, wherein more preferably each additive is selected from the group consisting of an oxidative agent and a reductive agent;
   wherein the oxidative agent is more preferably hydroperoxide, more preferably one or more of hydrogen peroxide, t-butyl hydroperoxide, isoamyl hydroperoxide, isoamyl hydroperoxide and cumene hydroperoxide, more preferably t-butyl hydroperoxide; wherein the reductive agent is more preferably one or more of ascorbic acid, its Na salt, isoascorbic acid, its Na salt, sulfite and its adducts to aldehydes or ketones, e.g. Rongalit C (Sodium formaldehydesulfoxylate), Aceton-Bisulfit.

Preferably, (v) comprises introducing water, ascorbic acid and t-butyl hydroperoxide. It is noted that ascorbic acid and t-butyl hydroperoxide are used for chemical deodorization and could be replaced by equivalent components by the skilled person.

In the context of the present invention, it is preferred that the process has an overall duration in the range of from 180 to 500 minutes, more preferably in the range of from 200 to 450 minutes, more preferably in the range of from 210 to 420 minutes.

The process of the present invention preferably consists of (i), (ii), (iii), (iv) and more preferably (v).

The present invention further relates to an aqueous polymer dispersion obtainable or obtained by a process according to the present invention, said dispersion having a polymer content of at least 50 weight-% based on the total weight of the aqueous polymer dispersion, wherein the polymer particles of the aqueous polymer dispersion exhibit a polymodal particle size distribution.

Preferably the aqueous polymer dispersion has a polymer content of at least 55 weight-%, more preferably in the range of from 55 to 75 weight-%, more preferably in the range of from 60 to 70 weight-%, preferably being determined as described in Reference Example 1.2.

Preferably the aqueous polymer dispersion has a bimodal particle size distribution.

Preferably the aqueous polymer dispersion has a bimodal particle size distribution such that X weight-% of the particles of the dispersion have a diameter in the range of from 40 to 150 nm, more preferably from 50 to 125 nm, and Y weight-% of the particles of the dispersion have a diameter in the range of 180 to 400 nm, more preferably in the range of from 200 to 350 nm, wherein Y=100−X.

Preferably X is in the range of from 5 to 40, more preferably in the range of from 10 to 37, more preferably in the range of from 15 to 35.

Preferably the aqueous polymer dispersion has a pH in the range of from 5 to 9, more preferably in the range of from 6 to 8.5, more preferably in the range of from 6.5 to 8.

Preferably the aqueous polymer dispersion has a viscosity of at most 2500 mPas, more preferably at most 2000 mPas, wherein the viscosity is more preferably in the range of from 100 to 2000 mPas, more preferably in the range of from 200 to 1500 mPas, the viscosity being determined as described in Reference Example 1.3.

Preferably the aqueous polymer dispersion has a fine coagulum, defined in μg of coagulate particles (coagulate particles having a diameter of at least 10 μm) per gram of the aqueous dispersion, which is of at most 7500 μg/g, more preferably at most 2500 μg/g, more preferably of at most 2200 μg/g, more preferably in the range of from 50 to 2200 μg/g, the fine coagulum being determined as described in Reference Example 1.5.

The present invention further relates to a use of an aqueous polymer dispersion according to the present invention in an aqueous formulation for one or more of coating, sealant and adhesive bonding. Preferably the aqueous formulation is for coating, sealant and adhesive bonding.

The present invention further relates to an aqueous formulation (suitable) for one or more of coating, sealant and adhesive bonding, preferably for coating, sealant and adhesive bonding, the aqueous formulation comprising an aqueous polymer dispersion according to the present invention, wherein the polymer content originating from the aqueous dispersion is in the range of from 5 to 90 weight-% based on the total weight of the aqueous formulation. As to the amount of said aqueous polymer dispersion, it is noted that the skilled person would know how to adapt it in an aqueous formulation depending on the use of said formulation, namely for a coating, for a sealant and/or for an adhesive coating.

Preferably the aqueous formulation further comprises at least one pigment and/or at least one filler. More preferably, the aqueous formulation is obtainable or obtained by a process compressing combining one or more slurries comprising the at least one pigment and/or the at least one filler, more preferably comprising the at least one pigment and the at least one filler, with an aqueous polymer dispersion according to the present invention.

Suitable pigments can be titanium dioxide (TiO₂). The pigment can also be, for example, an inorganic white pigment, such as barium sulfate, zinc oxide, zinc sulfide, basic lead carbonate, antimony trioxide, or lithopone (zinc sulfide+barium sulfate), or a colored pigment, such as iron oxide, carbon black, graphite, zinc yellow, zinc green, ultramarine, manganese black, antimony black, manganese violet, Prussian blue or Paris green. In addition to the inorganic pigments, the coating of the present invention may also comprise organic color pigments, such as sepia, gamboge, Cassel brown, toluidine red, para red, Hansa yellow, indigo, azo dyes, anthraquinonoid and indigoid dyes, and also dioxazine, quinacridone pigments, phthalocyanine pigments, isoindolinone pigments and metal complex pigments. Further suitable pigments are synthetic white pigments with air inclusions to enhance light scattering, such as the Ropaque® and AQACell® dispersions. Additionally suitable pigments are from the Luconyl® brands from BASF SE, for example Luconyl® yellow, Luconyl® brown and Luconyl® red, particularly the transparent versions.

Suitable fillers are, for example, aluminosilicates, such as feldspars, silicates, such as kaolin, talc, mica, magnesite, alkaline earth metal carbonates, such as calcium carbonate, for example in the form of calcite or chalk, magnesium carbonate, dolomite, alkaline earth metal sulfates, such as calcium sulfate, silicon dioxide, etc. Of course, finely divided fillers are preferred in paints. The fillers can be used as individual components. In practice, however, filler mixtures have proven particularly useful, for example calcium carbonate/kaolin, calcium carbonate/talc. Gloss paints have as a rule only small amounts of very finely divided fillers or comprise no fillers.

Preferably, the aqueous formulation further comprises one or more of wetting agents or dispersants, filming auxiliaries, thickeners, leveling agents, biocides, defoamers and curing catalysts.

Wetting agents or dispersants may be one or more of sodium polyphosphates, such as sodium 1-hydroxyethane-1,1-diphosphonate, potassium polyphosphates, ammonium polyphosphates, alkali metal salts of acrylic acid copolymers, ammonium salts of acrylic acid copolymers, maleic anhydride copolymers, and naphthalenesulfonic salts, especially the sodium salts thereof.

Suitable filming auxiliaries may be Texanol® from Eastman Chemicals and the glycol ethers and esters, commercially available from BASF SE under the Solvenon® and Lusolvan® names and from Dow under the Dowanol® trade name. The amount of filming auxiliaries is preferably less than 10 weight-%, more preferably less than 5 weight-%, based on the weight of the aqueous formulation.

Suitable thickeners may be associative thickeners, such as polyurethane thickeners. The amount of the thickener is generally less than 2.5 weight-%, more preferably less than 1.5 weight-%, more preferably in the range of from 0.05 to 1 weight-%, based on the solid content of the aqueous formulation.

Curing catalysts can be used when the aqueous formulation contains a curable binder, e.g. an acid curable binder, a thermally curable binder or a photocurable binder. Suitable curing catalysts will depend on the kind of binder used.

The present invention further relates to a process for preparing an aqueous formulation, preferably the aqueous formulation according to the present invention, the process comprising
(I) providing one or more slurries comprising at least one pigment and/or at least one filler, preferably comprising at least one pigment and at least one filler;
(II) combining the one or more slurries provided according to (I) with an aqueous polymer dispersion according to the present invention.

Preferably, (I) comprises
(I.1) mixing one or more powders comprising the at least one pigment with one or more powders comprising the at least one filler, obtaining one or more powder mixtures;
(I.2) adding water to the one or more powder mixtures obtained according to (I.1), obtaining one or more slurries comprising the at least one pigment and the at least one filler.
II. Further process for preparing an aqueous polymer dispersion

Therefore, the present invention further relates to a process for preparing an aqueous polymer dispersion having a polymer content of at least 50 weight-% based on the total weight of the aqueous polymer dispersion, the process comprising
(a) preparing a first aqueous mixture Y(1) comprising water and a seed latex, wherein the seed latex is an aqueous polymer dispersion exhibiting a monomodal particle size distribution, the polymer particles of the seed latex having an average diameter in the range of from 10 to 100 nm being determined as described in Reference Example 1.2;
(b) preparing a second aqueous mixture Y(2) comprising water, ethylenically unsaturated monomers which exhibit a Bronsted acidic group, ethylenically unsaturated monomers which do not exhibit a Bronsted acidic group and a base;
(c) introducing the first aqueous mixture Y(1) according to (a) into a polymerization vessel;
(d) introducing the second aqueous mixture Y(2) into the polymerization vessel comprising the first aqueous mixture Y(1) according to (a) and subjecting to copolymerization, obtaining said aqueous polymer dispersion;
   wherein the polymer particles of the aqueous polymer dispersion obtained according to (d) exhibit a polymodal particle size distribution;
   wherein at least 95 weight-% of the polymers comprised in the aqueous polymer dispersion are based on the monomers employed according to (b) and (d).

### First Aqueous Mixture Y(1)—Pre-Charge

Preferably the seed latex comprised in the first aqueous mixture Y(1) prepared according to (a) being an aqueous polymer dispersion has a polymer content in the range of from 20 to 50 weight-%, more preferably in the range of from 25 to 42 weight-%, based on the total weight of the seed latex.

Preferably the polymer particles of the seed latex have an average diameter in the range of from 10 to 90 nm, more preferably in the range of from 15 to 80 nm, more preferably in the range of from 20 to 40 nm, being determined as described in Reference Example 1.2.

Preferably the polymer of the seed latex comprised in the first aqueous mixture Y(1) prepared according to (a) is selected from the group consisting of polystyrene, styrene-acrylate copolymer, polyacrylate and a mixture of two or more thereof, more preferably is selected from the group consisting of polystyrene and styrene-acrylate copolymer, more preferably is polystyrene or styrene-acrylate copolymer.

Preferably the first aqueous mixture Y(1) is free of a base.

Preferably the first aqueous mixture Y(1) exhibits a pH in the range of from 6 to 9, more preferably in the range of from 7 to 8.5.

Preferably, (a) comprises
(a.1) admixing water and a seed latex under an inert gas atmosphere, wherein the seed latex is an aqueous polymer dispersion exhibiting a monomodal particle size distribution, the polymer particles of the seed latex having an average diameter as defined in the foregoing, being determined as described in Reference Example 1.2;
(a.2) heating the mixture obtained according to (a.1) to a temperature in the range of from 70 to 100° C., more preferably in the range of from 80 to 90° C., more preferably while stirring;
wherein (a) more preferably consists of (a.1) and (a.2).

As to admixing according to (a.1), it is preferred that it is performed at a temperature in the range of from 15 to 35° C., more preferably in the range of from 18 to 30° C., more preferably in the range of from 20 to 25° C. In other words, it is preferred that admixing according to (a.1) be performed at room temperature.

It is however noted that admixing according to (a.1) can also be performed at higher temperature. The skilled person would know how to choose the adequate temperature for (a.1).

Preferably the inert gas atmosphere is a nitrogen gas atmosphere.

### Second Aqueous Mixture Y(2)

Monomers which Exhibit a Bronsted Acidic Group

Preferably the ethylenically unsaturated monomers which exhibit a Bronsted acidic group comprised in the second mixture Y(2) prepared according to (b) are selected from the group consisting of monoethylenically unsaturated monocarboxylic acids having 3 to 6 carbon atoms, monoethylenically unsaturated dicarboxylic acids having 4 to 6 carbon atoms, monoethylenically unsaturated sulfonic acids, monoethylenically unsaturated phosphonic acids, monoethylenically unsaturated phosphoric acids and a mixture of two or more thereof.

More preferably the ethylenically unsaturated monomers which exhibit a Bronsted acidic group comprised in the second aqueous mixture Y(2) prepared according to (ii) are:
monoethylenically unsaturated monocarboxylic acids having 3 to 6 carbon atoms; or
monoethylenically unsaturated monocarboxylic acids having 3 to 6 carbon atoms and monoethylenically unsaturated sulfonic acids.

Preferably the total amount of monomers which exhibit a Bronsted acidic group comprised in the second aqueous mixture Y(2) prepared according to (b) is in the range of from 0.5 to 5 pphm, more preferably in the range of from 1 to 3 pphm based on the total amount of monomers comprised in the second aqueous mixture Y(2). Here, “pphm” refers to parts per hundred monomers, this permits to evaluate the amount of the monomers, which exhibit a Bronsted acidic group comprised in the second aqueous mixture prepared according to (b), in the second mixture relative to 100 parts of the monomers forming the second aqueous mixture Y(2).

As to the monoethylenically unsaturated monocarboxylic acid having 3 to 6 carbon atoms, it is preferred that it is one or more of methacrylic acid, acrylic acid, crotonic acid, 2-ethylpropenoic acid, 2-propylpropenoic acid, 2-acryloxyacetic acid and 2-methacyloxyacetic acid, more preferably one or more of methacrylic acid and acrylic acid, more preferably methacrylic acid or acrylic acid.

As to the monoethylenically unsaturated dicarboxylic acid having 4 to 6 carbon atoms, it is preferred that it is one or more of itaconic acid, maleic acid and fumaric acid.

More preferably the ethylenically unsaturated monomers which exhibit a Bronsted acidic group comprised in the second mixture Y(2) prepared according to (b) are methacrylic acids or acrylic acids.

As to the monoethylenically unsaturated sulfonic acid, it is preferred that it is one or more of 2-acrylamido-2-methylpropane sulfonic acid (AMPS), vinylsulfonic acid, allylsulfonic acid, sulfoethyl methacrylate, sulfopropyl methacrylate and styrenesulfonic acid, more preferably one or more of AMPS and vinylsulfonic acid more preferably AMPS.

As to the monoethylenically unsaturated phosphonic acid, it is preferred that it is one or more of vinylphosphonic acid, allylphosphonic acid, styrenephosphonic acid and 2-acrylamido-2-methylpropane phosphonic acid, more preferably vinylphosphonic acid.

As to the monoethylenically unsaturated phosphoric acids, it is preferred that it is one or more of monophosphates of hydroxyalkyl acrylates, monophosphates of hydroxyalkyl methacrylates, monophosphates of alkoxylated hydroxyalkyl acrylates and monophosphates of alkoxylated hydroxyalkyl methacrylates, more preferably one or more of monophosphates of hydroxyethyl acrylate, hydroxypropyl acrylate or hydroxybutyl acrylate, monophosphates of hydroxyethyl methacrylate, hydroxypropyl methacrylate or hydroxybutyl methacrylate, monophosphates of ethoxylated hydroxy-C2-C4-alkyl acrylates, monophosphates of propoxylated hydroxy-C2-C4-alkyl acrylates, monophosphates of ethoxylated hydroxy-C2-C4-alkyl methacrylates and monophosphates of propoxylated hydroxy-C2-C4-alkyl methacrylates, more preferably one or more of monophosphates of hydroxyethyl methacrylate, monophosphates of ethoxylated hydroxy-C2-C4-alkyl methacrylates and monophosphates of propoxylated hydroxy-C2-C4-alkyl methacrylates.

In the context of the present invention, the aforementioned monomers can be present in their acidic form or in the form of their salts, preferably in the form of their alkali metal salts or ammonium salts.

As to preferred different aspects of the present invention, it is more preferred that the ethylenically unsaturated monomers which exhibit a Bronsted acidic group comprised in the second aqueous mixture Y(2) prepared according to (ii) are
methacrylic acids; or
acrylic acids; or
methacrylic acids and 2-acrylamido-2-methylpropane sulfonic acid (AMPS); or
acrylic acids and 2-acrylamido-2-methylpropane sulfonic acid (AMPS).
   Monomers which do not Exhibit a Bronsted Acidic Group

Preferably the monomers which do not exhibit a Bronsted acidic group comprised in the second aqueous mixture Y(2) prepared according to (b) comprises one or more of C₁-C₂₀ alkyl esters of acrylic acid, C₁-C₂₀ alkyl esters of methacrylic acid, C₅-C₂₀ cycloalkyl esters of acrylic acid, C₅-C₂₀ cycloalkyl esters of methacrylic acid, C₅-C₂₀ cycloalkylmethyl esters of acrylic acid, C₅-C₂₀ cycloalkylmethyl esters of methacrylic acid, wherein the cycloalkyl in the aforementioned monomers is mono-, bi- or tricyclic and wherein 1 or 2 nonadjacent CH₂ moieties of the cycloalkyl may be replaced by oxygen atoms and wherein the cycloalkyl may be unsubstituted or carry 1, 2, 3 or 4 methyl groups, and vinylaromatic monomers, wherein more preferably the monomers which do not exhibit a Bronsted acidic group comprised in the second aqueous mixture Y(2) prepared according to (b) comprises C₁-C₂₀ alkyl esters of acrylic acid and vinylaromatic monomers.

As to the C₁-C₂₀ alkyl ester of acrylic acid, it is preferred that it is selected from the group consisting of methyl acrylate, ethyl acrylate, n-propyl acrylate, isopropyl-acrylate, n-butyl acrylate, 2-butyl acrylate, isobutyl acrylate, tert-butyl acrylate, n-pentyl acrylate, isoamyl acrylate, n-hexyl acrylate, n-octyl acrylate, 2-octyl acrylate, 2-ethylhexyl acrylate, n-decyl acrylate, 2-propylheptyl acrylate, lauryl acrylate, C12/C14-alkyl acrylate, and a mixture of two or more thereof, more preferably selected from the group consisting of n-butyl acrylate, iso-butyl acrylate, tert-butyl acrylate, 2-octyl acrylate, 2-ethylhexyl acrylate, and a mixture of two or more thereof, more preferably is selected from the group consisting of n-butyl acrylate, 2-ethylhexyl acrylate and a mixture thereof.

As to the monomers which do not exhibit a Bronsted acidic group comprised in the second aqueous mixture Y(2) prepared according to (b), it is more preferred that it comprises
styrene and n-butyl acrylate; or
styrene, n-butyl acrylate and 2-ethylhexyl acrylate.

Preferably the total amount of C₁-C₂₀ alkyl esters of acrylic acid in the mixture Y(2) is in the range of from 20 to 80 pphm, more preferably in the range of from 30 to 65 pphm, more preferably in the range of from 40 to 60 pphm, based on the total amount of monomers comprised in the second aqueous mixture Y(2). Here, “pphm” refers to parts per hundred monomers, this permits to evaluate the amount of the monomers, namely the C₁-C₂₀ alkyl esters of acrylic acid in the second aqueous mixture Y(2) prepared according to (b), in the second mixture Y(2) relative to 100 parts of the monomers forming the second aqueous mixture Y(2).

As to the vinylaromatic monomer, it is preferred that it is a mono-vinyl substituted aromatic hydrocarbons selected from the group consisting of styrene, 2-methylstyrene, 4-methylstyrene, 2-n-butylstyrene, 4-n-butylstyrene, 4-n-decylstyrene, α-methylstyrene and a mixture of two or more thereof, more preferably selected from the group consisting of styrene, 4-methylstyrene and α-methylstyrene, more preferably styrene.

Preferably the total amount of the vinylaromatic monomers in the mixture Y(2) is in the range of 30 to 69.5 pphm, more preferably in the range of from 35 to 59 pphm based on the total amount of monomers comprised in the second aqueous mixture Y(2). Here, “pphm” refers to parts per hundred monomers, this permits to evaluate the amount of the monomers, namely the vinylaromatic monomers in the second aqueous mixture Y(2) prepared according to (b), in the second mixture Y(2) relative to 100 parts of the monomers forming the second aqueous mixture Y(2).

Preferably, in the second aqueous mixture Y(2) prepared according to (b), the degree of neutralization of the monomers which exhibit a Bronsted acidic group is in the range of from 5 to 250%, more preferably in the range of from 10 to 200%, more preferably in the range of from 15 to 150%, the degree of neutralization being determined by the molar ratio of the amount of base to the amount of carboxylic acid functionalities.

Preferably, in the second aqueous mixture Y(2) prepared according to (b), the molar ratio of the base to the Bronsted acidic group of the monomers which exhibit a Bronsted acidic group is in the range of from 0.05:1 to 2.5:1, more preferably in the range of from 0.10:1 to 2:1, more preferably in the range of from 0.15:1 to 1.5:1.

Preferably Tg(Y(2)) is in the range of from −10 to 40° C., more preferably in the range of from −5 to 30° C., more preferably in the range of from −5 to 9° C., more preferably in the range of from 0 to 8° C., or more preferably in the range of from 10 to 30° C., more preferably in the range of from 12 to 25° C., Tg(Y(2)) being the theoretical glass transition temperature (Tg) of the polymer which would be obtained from polymerization of the monomers of the mixture Y(2), wherein said theoretical glass transition temperatures Tg(Y(2)) is determined according to the Fox equation.

Preferably the base comprised in the second aqueous mixture Y(2) prepared according to (b) is selected from the group consisting of sodium hydroxide, ammonium hydroxide, sodium carbonate, ammonium bicarbonate, potassium hydroxide, calcium hydroxide, sodium bicarbonate, more preferably selected from the group consisting of sodium hydroxide, ammonium hydroxide and potassium hydroxide, more preferably is sodium hydroxide.

### Further Monomers

Preferably the second aqueous mixture Y(2) prepared according to (b) may further comprise monoethylenically unsaturated silane functional monomers. Said monoethylenically unsaturated silane functional monomers are preferably monomers which in addition to an ethylenically unsaturated double bond bear at least one mono-, di- and/or tri-C1-C₄-alkoxysilane group. Preferred monoethylenically unsaturated silane functional monomer are one or more of vinyl triethoxysilane (VTEO), 3-methacryloxypropyl trimethoxysilane (MEMO), vinyl trimethoxysilane, methacryloxymethyl trimethoxysilane and methacryloxymethyl triethoxysilane.

More preferably the second aqueous mixture Y(2) prepared according to (ii) may further comprise one or more of vinyl triethoxysilane (VTEO) and 3-methacryloxypropyl trimethoxysilane (MEMO), more preferably 3-methacryloxypropyl trimethoxysilane (MEMO) or vinyl triethoxysilane (VTEO).

As to a preferred aspect of the present invention, it is more preferred that the second aqueous mixture Y(2) prepared according to (b) comprises
methacrylic acids as the ethylenically unsaturated monomers which exhibit a Bronsted acidic group and MEMO or VTEO as the silane monomers; or
acrylic acids as the ethylenically unsaturated monomers which exhibit a Bronsted acidic group and MEMO or VTEO as the silane monomer; or
methacrylic acids, 2-acrylamido-2-methylpropane sulfonic acid (AMPS) and MEMO or VTEO as the silane monomers; or
acrylic acids, 2-acrylamido-2-methylpropane sulfonic acid (AMPS) and MEMO or VTEO as the silane monomers.

### Other Components

Preferably the second aqueous mixture Y(2) further comprises one or more surfactants, wherein the surfactants are each selected from the group consisting of an anionic surfactant, a non-ionic surfactant and a mixture thereof.

As to the anionic surfactant, it is preferred that it comprises at least one anionic group, which is more preferably selected from the group consisting of a phosphate group, a phosphonate group, a sulfate group and a sulfonate group.

Preferably from 0 to 5 weight-%, more preferably from 0.1 to 3 weight-%, more preferably from 0.2 to 2 weight-%, of the the second aqueous mixture Y(2) consist of the one or more surfactants.

Preferably the surfactant is an anionic surfactant, being more preferably an anionic emulsifier comprising at least one a sulfate group or a sulfonate group, more preferably a sulfate group.

Preferably the anionic emulsifier comprising a sulfate group is a salt of alkyl sulfates or alkyl ether sulfates, more preferably C8-C22-alkyl sulfates or alkyl ether sulfates.

Suitable surfactants/emulsifiers for the second aqueous mixture Y(2) can be those listed for the second aqueous mixture X(2) described under item I. in the foregoing.

Preferably the second aqueous mixture Y(2) is an emulsion.

Preferably the second aqueous mixture Y(2) comprises water, the ethylenically unsaturated monomers which exhibit a Bronsted acidic group, the ethylenically unsaturated monomers which do not exhibit a Bronsted acidic group, the base and one or more surfactants as defined in the foregoing.

Preferably from 98 to 100 weight-%, more preferably from 99 to 100 weight-%, more preferably from 99.5 to 100 weight-%, more preferably from 99.9 to 100 weight-%, of the second aqueous mixture Y(2) consist of water, the ethylenically unsaturated monomers which exhibit a Bronsted acidic group, the ethylenically unsaturated monomers which do not exhibit a Bronsted acidic group, the base and one or more surfactants as defined in the foregoing.

### Third Aqueous Mixture Y(3)—Initiator

Preferably the process of the present invention further comprises introducing a third aqueous mixture Y(3) into the polymerization vessel comprising the first aqueous mixture Y(1), wherein the third aqueous mixture Y(3) comprises water and an initiator.

Preferably the initiator is a free-radical initiator, being more preferably inorganic peroxide, more preferably peroxodisulfate salt, more preferably sodium peroxodisulfate.

Suitable initiators for the third aqueous mixture Y(3) can be those listed for the third aqueous mixture X(3) described under item I. in the foregoing.

Preferably the amount of the initiator comprised in the third aqueous mixture Y(3) is in the range of from 0.1 to 1 weight-%, more preferably in the range of from 0.25 to 0.90 weight-%, based on the total amount of monomers comprised in the second aqueous mixture Y(2).

### Feeds

Preferably, according to (d), the second aqueous mixture Y(2) is introduced continuously into the polymerization vessel as a first feed.

Preferably the first feed is introduced continuously at a constant feed rate.

Preferably the first feed is introduced into the polymerization vessel according to (d) at different feed rates, F1-Fx, with x=2 or more, wherein F1<Fx, wherein the feed rates are >0 g/h.

Preferably introducing the second aqueous mixture Y(2) into the polymerization vessel according to (d) is performed for a period in the range of from 90 to 350 minutes, more preferably in the range of from 100 to 320 minutes.

Preferably the third aqueous mixture Y(3) is introduced continuously into the polymerization vessel as a second feed.

Preferably the second feed (initiator) is introduced into the polymerization vessel at different feed rates, F1-Fx, with x=2 or more, more preferably 2, in g/h, wherein the feed rates are >0 g/h, wherein F1<Fx.

Preferably introducing the third aqueous mixture Y(3) into the polymerization vessel is performed for a period in the range of from 150 to 400 minutes, more preferably in the range of from 175 to 330 minutes.

Preferably introducing the second aqueous mixture Y(2) according to (d) is performed at a time T(M) and introducing the third aqueous mixture Y(3) as defined in the foregoing is performed at a time T(I), wherein T(M)≤T(I), more preferably T(M)+3 min≤T(I), more preferably T(M)+5 min≤T(I).

Preferably co-polymerization into the polymerization vessel according (d) is conducted at a temperature in the range of from 70 to 100° C., more preferably in the range of from 80 to 90° C.

The process of the present invention preferably further comprises introducing a seed latex, preferably a polystyrene aqueous dispersion, at a time T(S) into the polymerization vessel, wherein T(S) starts when at least 5 weight-%, preferably at least 10 weight-%, more preferably at least 15 weight-%, more preferably from 15 to 70 weight-%, more preferably from 20 to 60 weight-%, of the aqueous mixture Y(2) have been introduced into the polymerization vessel. Without wanting to be bound to any theory, it is believed that the addition of the seed latex at a time T(S) into the polymerization vessel permits to trigger the change in particle distribution of the polymer of the final dispersion, namely the aqueous polymer dispersion according to the present invention. Such step would then permit to control the change.

It is however noted that the change of the particle size distribution of the polymer of the final dispersion, namely the aqueous polymer dispersion according to the present invention, will also occur when no seed latex is added. The skilled person will however have less control of the time at which the change will be triggered. Thus, it is also preferred that no seed latex is further introduced in the polymerization vessel comprising the second aqueous mixture Y(2).

Preferably the process of the present invention further comprises introducing a surfactant, preferably as defined in the foregoing, at a time T(E) into the polymerization vessel, wherein T(E) starts when at least 2 weight-%, more preferably at least 3 weight-%, more preferably from 3 to 60 weight-%, more preferably from 3 to 10 weight-% or more preferably from 40 to 60 weight-%, of the aqueous mixture Y(2) have been introduced into the polymerization vessel. Without wanting to be bound to any theory, it is believed that said addition of surfactant at a time T(E) will permit to obtain the same results as with the addition of seed latex at a time T(S). This addition can thus be used as an alternative to the seed latex addition.

Preferably from 95 to 100 weight-%, more preferably from 98 to 100 weight-%, of the polymers comprised in the aqueous polymer dispersion are based on the monomers employed according to (b) and (d).

Preferably the process of the present invention further comprises
(e) introducing water and one or more additives into the polymerization vessel, wherein more preferably each additive is selected from the group consisting of an oxidative agent and a reductive agent;
   wherein the oxidative agent is more preferably hydroperoxide, more preferably one or more of hydrogen peroxide, t-butyl hydroperoxide, isoamyl hydroperoxide, isoamyl hydroperoxide and cumene hydroperoxide, more preferably t-butyl hydroperoxide; wherein the reductive agent is more preferably one or more of ascorbic acid, its Na salt, isoascorbic acid, its Na salt, sulfite and its adducts to aldehydes and ketones, e.g. Rongalit C (Sodium formaldehydesulfoxylate), Aceton-Bisulfit.

Preferably, (e) comprises introducing water, ascorbic acid and t-butyl hydroperoxide. It is noted that ascorbic acid and t-butyl hydroperoxide are used for chemical deodorization and could be replaced by equivalent components by the skilled person.

In the context of the present invention, it is preferred that the process has an overall duration in the range of from 180 to 500 minutes, more preferably in the range of from 200 to 450 minutes, more preferably in the range of from 210 to 420 minutes.

Preferably, the process of the present invention consists of (a), (b), (c), (d) and more preferably (e).

The present invention further relates to an aqueous polymer dispersion obtainable or obtained by a process according to the process of the present invention, said dispersion having a polymer content of at least 50 weight-% based on the total weight of the aqueous polymer dispersion, wherein the polymer particles of the aqueous polymer dispersion exhibit a polymodal particle size distribution.

Preferably the aqueous polymer dispersion has a polymer content of at least 55 weight-%, more preferably in the range of from 55 to 75 weight-%, more preferably in the range of from 60 to 70 weight-%, more preferably in the range of from 61 to 63 weight-%, preferably being determined as described in Reference Example 1.2.

Preferably the aqueous polymer dispersion has a bimodal particle size distribution.

Preferably the aqueous polymer dispersion has a bimodal particle size distribution such that X weight-% of the particles of the dispersion have a diameter in the range of from 40 to 150 nm, more preferably in the range of from 50 to 125 nm, and Y weight-% of the particles of the dispersion have a diameter in the range of from 180 to 400 nm, more preferably in the range of from 200 to 350 nm, wherein Y=100−X.

Preferably X is in the range of from 5 to 40, more preferably in the range of from 10 to 37, more preferably in the range of from 15 to 35.

Preferably the aqueous polymer dispersion has a pH in the range of from 5 to 9, more preferably in the range of from 6 to 8.5, more preferably in the range of from 6.5 to 8.

Preferably the aqueous polymer dispersion has a viscosity of at most 2500 mPas, more preferably at most 2000 mPas, wherein the viscosity is more preferably in the range of from 100 to 2000 mPas, more preferably in the range of from 200 to 1500 mPas, the viscosity being determined as described in Reference Example 1.3.

Preferably the aqueous polymer dispersion has a fine coagulum, defined in μg of coagulate particles (coagulate particles having a diameter of at least 10 μm) per gram of the aqueous dispersion, which is of at most 7500 μg/g, more preferably of at most 2500 μg/g, more preferably of at most 2200 μg/g, more preferably in the range of from 50 to 2200 μg/g, the fine coagulum being determined as described in Reference Example 1.5.

The present invention further relates to a use of an aqueous polymer dispersion according to the present invention in an aqueous formulation for one or more of coating, sealant and adhesive bonding. Preferably the aqueous formulation is for coating, sealant and adhesive bonding.

The present invention further relates to an aqueous formulation for one or more of coating, sealant and adhesive bonding, preferably for coating, sealant and adhesive bonding, the aqueous formulation comprising an aqueous polymer dispersion according to the present invention, wherein the polymer content originating from the aqueous dispersion is in the range of from 5 to 90 weight-% based on the total weight of the aqueous formulation. As to the amount of said aqueous polymer dispersion, it is noted that the skilled person would know how to adapt it in an aqueous formulation depending on the use of said formulation, namely for a coating, for a sealant and/or for an adhesive coating.

Preferably the aqueous formulation further comprises at least one pigment and/or at least one filler. More preferably, the aqueous formulation is obtainable or obtained by a process comprising combining one or more slurries comprising the at least one pigment and/or the at least one filler, more preferably comprising the at least one pigment and the at least one filler, with an aqueous polymer dispersion according to the present invention.

Examples of suitable pigments and fillers are disclosed under item I. in the foregoing.

Preferably the aqueous formulation further comprises one or more of wetting agents or dispersants, filming auxiliaries, thickeners, leveling agents, biocides, defoamers and curing catalysts. Examples of such components are disclosed under item I. in the foregoing.

The present invention further relates to a process for preparing an aqueous formulation, preferably the aqueous formulation according to the present invention, the process comprising
(A) providing one or more slurries comprising at least one pigment and/or at least one filler, preferably comprising at least one pigment and at least one filler;
(B) combining the one or more slurries provided according to (A) with an aqueous polymer dispersion according to the present invention.

Preferably, (A) comprises
(A.1) mixing one or more powders comprising the at least one pigment with one or more powders comprising the at least one filler, obtaining one or more powder mixtures;
(A.2) adding water to the one or more powder mixtures obtained according to (A.1), obtaining one or more slurries comprising the at least one pigment and the at least one filler.

The present invention is further illustrated by the following first set of embodiments and combinations of embodiments resulting from the dependencies and back-references as indicated. In particular, it is noted that in each instance where a range of embodiments is mentioned, for example in the context of a term such as “The process of any one of embodiments 1 to 4”, every embodiment in this range is meant to be explicitly disclosed for the skilled person, i.e. the wording of this term is to be understood by the skilled person as being synonymous to “The process of any one of embodiments 1, 2, 3 and 4”. Further, it is explicitly noted that the following set of embodiments represents a suitably structured part of the general description directed to preferred aspects of the present invention, and, thus, suitably supports, but does not represent the claims of the present invention.
1. A process for preparing an aqueous polymer dispersion having a polymer content of at least 50 weight-% based on the total weight of the aqueous polymer dispersion, the process comprising
   (i) preparing a first aqueous mixture X(1) comprising water and a first base,
   (ii) preparing a second aqueous mixture X(2) comprising water, ethylenically unsaturated monomers which exhibit a Bronsted acidic group, ethylenically unsaturated monomers which do not exhibit a Bronsted acidic group and a second base;
   (iii) introducing the first aqueous mixture X(1) according to (i) into a polymerization vessel;
   (iv) introducing the second aqueous mixture X(2) into the polymerization vessel comprising the first aqueous mixture X(1) according to (i) and subjecting to copolymerization, obtaining said aqueous polymer dispersion;
   wherein the polymer particles of the aqueous polymer dispersion obtained according to (iv) exhibit a polymodal particle size distribution;
   wherein at least 95 weight-% of the polymers comprised in the aqueous polymer dispersion are based on the monomers employed according to (ii) and (iv).
2. The process of embodiment 1, wherein the first base comprises an anionic group and a counterion, the anionic group being selected from the group consisting of HCO₃⁻, P₂O₇⁴⁻, CH₃COO⁻, HPO₄²⁻, H₂PO₄⁻, C₃H₅O₃⁻, C₆H₅O₇³⁻ and CO₃²⁻, preferably selected from the group consisting of HCO₃⁻ and P₂O₇⁴⁻, more preferably is HCO₃⁻ or P₂O₇⁴⁻.
3. The process of embodiment 2, wherein the counterion comprised in the first base used according to (i) is selected from the group consisting of Na⁺, K⁺, NH₄⁺ and Li⁺, preferably selected from the group consisting of Na⁺ and NH₄⁺.
4. The process of embodiment 2 or 3, wherein the first base is selected from the group consisting of NaHCO₃, Na₄P₂O₇ and NH₄HCO₃.
5. The process of any one of embodiments 1 to 4, wherein the first aqueous mixture X(1) prepared according to (i) further comprises a seed latex, wherein the seed latex is an aqueous polymer dispersion having a polymer content in the range of from 20 to 50 weight-%, preferably in the range of from 25 to 42 weight-%, based on the total weight of the seed latex;
   wherein the polymer particles of the seed latex preferably exhibit a monomodal particle size distribution.
6. The process of embodiment 5, wherein the polymer particles of the seed latex have an average diameter in the range of from 10 to 100 nm, preferably in the range of from 15 to 80 nm, more preferably in the range of from 20 to 40 nm, being determined as described in Reference Example 1.2.
7. The process of embodiment 5 or 6, wherein the polymer of the seed latex is selected from the group consisting of polystyrene, styrene-acrylate copolymer, polyacrylate and a mixture of two or more thereof, preferably is selected from the group consisting of polystyrene and styrene-acrylate copolymer, more preferably is polystyrene or styrene-acrylate copolymer.
8. The process of any one of embodiments 1 to 7, wherein (i) comprises
   (i.1) admixing water and a first base under an inert gas atmosphere;
   (i.2) admixing a seed latex as defined in any one of embodiments 5 to 7 to the mixture obtained according to (i.1);
   (i.3) heating the mixture obtained according to (i.2) to a temperature in the range of from 70 to 100° C., preferably in the range of from 80 to 90° C., preferably while stirring;
   wherein (i) preferably consists of (i.1) and (i.2) and (i.3).
9. The process of embodiment 8, wherein admixing according to (i.1) is performed at a temperature in the range of from 15 to 35° C., preferably in the range of from 18 to 30° C., more preferably in the range of from 20 to 25° C.;
   wherein preferably admixing according to (i.2) is performed at a temperature in the range of from 15 to 35° C., more preferably in the range of from 18 to 30° C., more preferably in the range of from 20 to 25° C.
10. The process of any one of embodiments 1 to 9, wherein the ethylenically unsaturated monomers which exhibit a Bronsted acidic group comprised in the second mixture X(2) prepared according to (ii) are selected from the group consisting of monoethylenically unsaturated monocarboxylic acids having 3 to 6 carbon atoms, monoethylenically unsaturated dicarboxylic acids having 4 to 6 carbon atoms, monoethylenically unsaturated sulfonic acids, monoethylenically unsaturated phosphonic acids, monoethylenically unsaturated phosphoric acids and a mixture of two or more thereof, preferably are monoethylenically unsaturated monocarboxylic acids having 3 to 6 carbon atoms or monoethylenically unsaturated monocarboxylic acids having 3 to 6 carbon atoms and monoethylenically unsaturated sulfonic acids;
   wherein the total amount of monomers which exhibit a Bronsted acidic group comprised in the second aqueous mixture X(2) prepared according to (ii) is preferably in the range of from 0.5 to 5 pphm, more preferably in the range of from 1 to 3 pphm based on the total amount of monomers comprised in the second aqueous mixture X(2).
11. The process of embodiment 10, wherein the monoethylenically unsaturated monocarboxylic acid having 3 to 6 carbon atoms is one or more of methacrylic acid, acrylic acid, crotonic acid, 2-ethylpropenoic acid, 2-propylpropenoic acid, 2-acryloxyacetic acid and 2-methacyloxyacetic acid, preferably one or more of methacrylic acid and acrylic acid, more preferably methacrylic acid or acrylic acid; and
   wherein the monoethylenically unsaturated sulfonic acid is one or more of 2-acrylamido-2-methylpropane sulfonic acid (AMPS), vinylsulfonic acid, allylsulfonic acid, sulfoethyl methacrylate, sulfopropyl methacrylate and styrenesulfonic acid, more preferably one or more of AMPS and vinylsulfonic acid, more preferably AMPS.
12. The process of embodiment 10, wherein the monoethylenically unsaturated dicarboxylic acid having 4 to 6 carbon atoms is one or more of itaconic acid, maleic acid and fumaric acid.
13. The process of any one of embodiments 1 to 12, wherein the monomers which do not exhibit a Bronsted acidic group comprised in the second aqueous mixture prepared according to (ii) comprises one or more of C₁-C₂₀ alkyl esters of acrylic acid, C₁-C₂₀ alkyl esters of methacrylic acid, C₅-C₂₀ cycloalkyl esters of acrylic acid, C₅-C₂₀ cycloalkyl esters of methacrylic acid, C₅-C₂₀ cycloalkylmethyl esters of acrylic acid, C₅-C₂₀ cycloalkylmethyl esters of methacrylic acid, wherein the cycloalkyl in the aforementioned monomers is mono-, bi- or tricyclic and wherein 1 or 2 nonadjacent CH₂ moieties of the cycloalkyl may be replaced by oxygen atoms and wherein the cycloalkyl may be unsubstituted or carry 1, 2, 3 or 4 methyl groups, and vinylaromatic monomers, wherein preferably the monomers which do not exhibit a Bronsted acidic group comprised in the aqueous monomer mixture used in (ii) comprises C₁-C₂₀ alkyl esters of acrylic acid and vinylaromatic monomers.
14. The process of embodiment 13, wherein the C₁-C₂₀ alkyl ester of acrylic acid is selected from the group consisting of methyl acrylate, ethyl acrylate, n-propyl acrylate, isopropylacrylate, n-butyl acrylate, 2-butyl acrylate, isobutyl acrylate, tert-butyl acrylate, n-pentyl acrylate, isoamyl acrylate, n-hexyl acrylate, n-octyl acrylate, 2-octyl acrylate, 2-ethylhexyl acrylate, n-decyl acrylate, 2-propylheptyl acrylate, lauryl acrylate, C12/C14-alkyl acrylate, and a mixture of two or more thereof, preferably selected from the group consisting of n-butyl acrylate, iso-butyl acrylate, tert-butyl acrylate, 2-octyl acrylate, 2-ethylhexyl acrylate, and a mixture of two or more thereof, more preferably is selected from the group consisting of n-butyl acrylate, 2-ethylhexyl acrylate and a mixture thereof;
   wherein the total amount of C₁-C₂₀ alkyl esters of acrylic acid in the mixture X(2) preferably is in the range of 20 to 80 pphm, preferably in the range of from 30 to 65 pphm, more preferably in the range of from 40 to 60 pphm based on the total amount of monomers comprised in the second aqueous mixture X(2).
15. The process of embodiment 13, wherein the vinylaromatic monomer is a mono-vinyl substituted aromatic hydrocarbons selected from the group consisting of styrene, 2-methylstyrene, 4-methylstyrene, 2-n-butylstyrene, 4-n-butylstyrene, 4-n-decylstyrene, α-methylstyrene and a mixture of two or more thereof, preferably selected from the group consisting of styrene, 4-methylstyrene and α-methylstyrene, more preferably styrene; wherein the total amount of the vinylaromatic monomers in the mixture X(2) is preferably in the range of 30 to 69.5 pphm, more preferably in the range of from 35 to 59 pphm based on the total amount of monomers comprised in the second aqueous mixture X(2).
16. The process of any one of embodiments 1 to 15, wherein, in the second aqueous mixture X(2) prepared according to (ii), the degree of neutralization of the monomers which exhibit a Bronsted acidic group is in the range of from 5 to 250%, more preferably in the range of from 10 to 200%, more preferably in the range of from 15 to 150%, the degree of neutralization being determined by the molar ratio of the amount of base to the amount of carboxylic acid functionalities.
17. The process of any one of embodiments 1 to 16, wherein, in the second aqueous mixture X(2) prepared according to (ii), the molar ratio of the second base to the Bronsted acidic group of the monomers which exhibit a Bronsted acidic group is in the range of from 0.05:1 to 2.5:1, more preferably in the range of from 0.10:1 to 2:1, more preferably in the range of from 0.15:1 to 1.5:1.
18. The process of any one of embodiments 1 to 17, wherein Tg(X(2)) is in the range of from −10 to 40° C., preferably in the range of from −5 to 30° C., more preferably in the range of from −5 to 9° C., more preferably in the range of from 0 to 8° C., or more preferably in the range of from 10 to 30° C., more preferably in the range of from 12 to 25° C., Tg(X(2)) being the theoretical glass transition temperature (Tg) of the polymer which would be obtained from polymerization of the monomers of the mixture X(2), wherein said theoretical glass transition temperatures Tg(X(2)) is determined according to the Fox equation.
19. The process of any one of embodiments 1 to 18, wherein the second base comprised in the second aqueous mixture X(2) prepared according to (ii) is selected from the group consisting of sodium hydroxide, ammonium hydroxide, sodium carbonate, ammonium bicarbonate, potassium hydroxide, calcium hydroxide, sodium bicarbonate, preferably selected from the group consisting of sodium hydroxide, ammonium hydroxide and potassium hydroxide, more preferably is sodium hydroxide.
20. The process of any one of embodiments 1 to 19, wherein the second aqueous mixture X(2) prepared according to (ii) further comprises monoethylenically unsaturated silane functional monomers, said monoethylenically unsaturated silane functional monomers are preferably monomers which in addition to an ethylenically unsaturated double bond bear at least one mono-, di- and/or tri-C1-C₄-alkoxysilane group; wherein more preferably the monoethylenically unsaturated silane functional monomer are one or more of vinyl triethoxysilane (VTEO), 3-methacryloxypropyl trimethoxysilane (MEMO), vinyl trimethoxysilane, methacryloxymethyl trimethoxysilane and methacryloxymethyl triethoxysilane, more preferably one or more of vinyl triethoxysilane (VTEO) and 3-methacryloxypropyl trimethoxysilane (MEMO), more preferably vinyl triethoxysilane (VTEO) or 3-methacryloxypropyl trimethoxysilane (MEMO).
21. The process of any one of embodiments 1 to 20, wherein the second aqueous mixture X(2) further comprises one or more surfactants, wherein the surfactants are each selected from the group consisting of an anionic surfactant, a non-ionic surfactant and a mixture thereof,
   wherein the anionic surfactant preferably comprises at least one anionic group, which is more preferably selected from the group consisting of a phosphate group, a phosphonate group, a sulfate group and a sulfonate group;
   wherein preferably from 0 to 5 weight-%, more preferably from 0.1 to 3 weight-%, more preferably from 0.2 to 2 weight-%, of the the second aqueous mixture X(2) consist of the one or more surfactants.
22. The process of embodiment 21, wherein the surfactant is an anionic surfactant, being preferably an anionic emulsifier comprising at least one a sulfate group or a sulfonate group, more preferably a sulfate group.
23. The process of embodiment 22, wherein the anionic emulsifier comprising a sulfate group is a salt of alkyl sulfates or alkyl ether sulfates, preferably C8-C22-alkyl sulfates or C8-C22 alkyl ether sulfates.
24. The process of any one of embodiments 1 to 23, further comprising introducing a third aqueous mixture X(3) into the polymerization vessel comprising the first aqueous mixture X(1), wherein the third aqueous mixture X(3) comprises water and an initiator.
25. The process of embodiment 24, wherein the initiator is a free-radical initiator, being preferably inorganic peroxide, more preferably peroxodisulfate salt, more preferably sodium peroxodisulfate.
26. The process of embodiment 24 or 25, wherein the amount of the initiator comprised in the third aqueous mixture X(3) is in the range of from 0.1 to 1 weight-%, preferably in the range of from 0.25 to 0.80 weight-%, based on the total amount of monomers comprised in the second aqueous mixture X(2).
27. The process of any one of embodiments 1 to 26, wherein according to (iv) the second aqueous mixture X(2) is introduced continuously into the polymerization vessel as a first feed.
28. The process of embodiment 27, wherein the first feed is introduced continuously at a constant feed rate.
29. The process of embodiment 27, wherein the first feed is introduced into the polymerization vessel according to (iv) at different feed rates, F1-Fx, with x=2 or more, wherein F1<Fx, wherein the feed rates are >0 g/h.
30. The process of any one of embodiments 1 to 29, wherein introducing the second aqueous mixture X(2) into the polymerization vessel according to (iv) is performed for a period in the range of from 90 to 350 minutes, preferably in the range of from 100 to 320 minutes.
31. The process of any one of embodiments 24 to 26, and any one of embodiments 27 to 30 as far as it depends on any one of embodiments 24 to 26, wherein the third aqueous mixture X(3) is introduced continuously into the polymerization vessel as a second feed.
32. The process of embodiment 31, wherein the second feed is introduced into the polymerization vessel at different feed rates, F1-Fx, with x=2 or more, preferably 2, in g/h, wherein the feed rates are >0 g/h, wherein F1<Fx.
33. The process of embodiment 31 or 32, wherein introducing the third aqueous mixture X(3) into the polymerization vessel is performed for a period in the range of from 150 to 400 minutes, preferably in the range of from 175 to 330 minutes.
34. The process of any one of embodiments 1 to 33, wherein introducing the second aqueous mixture X(2) according to (iv) is performed at a time T(m) and introducing the third aqueous mixture X(3) as defined in any one of embodiments 21 to 23 is performed at a time T(i), wherein T(m)≤T(i), preferably T(m)+3 min≤T(i), more preferably T(m)+5 min≤ T(i).
35. The process of any one of embodiments 1 to 34, wherein the second aqueous mixture X(2) is an emulsion.
36. The process of any one of embodiments 1 to 35, wherein from 98 to 100 weight-%, preferably from 99 to 100 weight-%, more preferably from 99.5 to 100 weight-%, more preferably from 99.9 to 100 weight-%, of the second aqueous mixture M (2) consist of water, the ethylenically unsaturated monomers which exhibit a Bronsted acidic group, the ethylenically unsaturated monomers which do not exhibit a Bronsted acidic group, the second base and one or more surfactants as defined in any one of embodiments 17 to 20.
37. The process of any one of embodiments 1 to 36, wherein co-polymerization into the polymerization vessel according (iv) is conducted at a temperature in the range of from 70 to 100° C., preferably in the range of from 80 to 90° C.
38. The process of any one of embodiments 1 to 37, further comprising introducing a seed latex, preferably polystyrene, at a time T(s) into the polymerization vessel, wherein T(s) starts when at least 5 weight-%, preferably at least 10 weight-%, more preferably at least 15 weight-%, more preferably from 15 to 70 weight-%, more preferably from 20 to 60 weight-%, of the aqueous mixture X(2) have been introduced into the polymerization vessel.
39. The process of any one of embodiments 1 to 37, wherein no seed latex is further introduced in the polymerization vessel comprising the second aqueous mixture X(2).
40. The process of embodiment 39, further comprising introducing a surfactant, preferably as defined in any one of embodiments 20, 22 and 23, at a time T(e) into the polymerization vessel, wherein T(e) starts when at least 2 weight-%, preferably at least 3 weight-%, more preferably from 3 to 60 weight-%, more preferably from 3 to 10 weight-% or more preferably from 40 to 60 weight-%, of the aqueous mixture X(2) have been introduced into the polymerization vessel.
41. The process of any one of embodiments 1 to 40, wherein from 95 to 100 weight-%, preferably from 98 to 100 weight-%, of the polymers comprised in the aqueous polymer dispersion are based on the monomers employed according to (ii) and (iv).
42. The process of any one of embodiments 1 to 41, further comprising
   (v) introducing water and one or more additives into the polymerization vessel, wherein preferably each additive is selected from the group consisting of an oxidative agent and a reductive agent;
      wherein the oxidative agent is preferably hydroperoxide, more preferably one or more of hydrogen peroxide, t-butyl hydroperoxide, isoamyl hydroperoxide, isoamyl hydroperoxide and cumene hydroperoxide, more preferably t-butyl hydroperoxide; wherein the reductive agent is preferably one or more of ascorbic acid, its Na salt, isoascorbic acid, its Na salt, sulfite and its adducts to aldehydes or ketones; wherein (v) more preferably comprises introducing water, ascorbic acid and t-butyl hydroperoxide.
43. The process of any one of embodiments 1 to 42, having an overall duration in the range of from 180 to 500 minutes, preferably in the range of from 200 to 450 minutes, more preferably in the range of from 210 to 420 minutes.
44. The process of any one of embodiments 1 to 43, consisting of (i), (ii), (iii), (iv) and preferably (v).
45. An aqueous polymer dispersion obtainable or obtained by a process according to any one of embodiments 1 to 44, said dispersion having a polymer content of at least 50 weight-% based on the total weight of the aqueous polymer dispersion, wherein the polymer particles of the aqueous polymer dispersion exhibit a polymodal particle size distribution.
46. The aqueous polymer dispersion of embodiment 45, having a polymer content of at least 55 weight-%, preferably in the range of from 55 to 75 weight-%, more preferably in the range of from 60 to 70 weight-%, preferably being determined as described in Reference Example 1.2.
47. The aqueous polymer dispersion of embodiment 45 or 46, having a bimodal particle size distribution.
48. The aqueous polymer dispersion of embodiment 47, having a bimodal particle size distribution such that X weight-% of the particles of the dispersion have a diameter in the range of from 40 to 150 nm, preferably from 50 to 125 nm, and Y weight-% of the particles of the dispersion have a diameter in the range of 180 to 400 nm, preferably in the range of from 200 to 350 nm, wherein Y=100-X.
49. The aqueous polymer dispersion of embodiment 48, wherein X is in the range of from 5 to 40, preferably in the range of from 10 to 37, more preferably in the range of from 15 to 35.
50. The aqueous polymer dispersion of any one of embodiments 45 to 49, having a pH in the range of from 5 to 9, preferably in the range of from 6 to 8.5, more preferably in the range of from 6.5 to 8.
51. The aqueous polymer dispersion of any one of embodiments 45 to 50, having a viscosity of at most 2500 mPas, preferably at most 2000 mPas, wherein the viscosity is more preferably in the range of from 100 to 2000 mPas, more preferably in the range of from 200 to 1500 mPas, the viscosity being determined as described in Reference Example 1.3.
52. The aqueous polymer dispersion of any one of embodiments 45 to 51, having a fine coagulum, defined in μg of coagulate particles per gram of the aqueous dispersion, which is of at most 7500 μg/g, preferably at most 2500 μg/g, more preferably of at most 2200 μg/g, more preferably in the range of from 50 to 2200 μg/g, the fine coagulum being determined as described in Reference Example 1.5.
53. Use of an aqueous polymer dispersion according to any one of embodiments 46 to 52 in an aqueous formulation for one or more of coating, sealant and adhesive bonding, preferably the aqueous formulation being for coating, sealant and adhesive bonding.
54. An aqueous formulation for one or more of coating, sealant and adhesive bonding, preferably for coating, sealant and adhesive bonding, the aqueous formulation comprising an aqueous polymer dispersion according to any one of embodiments 45 to 52, wherein the polymer content originating from the aqueous dispersion is in the range of from 5 to 90 weight-% based on the total weight of the aqueous formulation.
55. The aqueous formulation of embodiment 54, further comprising at least one pigment and/or at least one filler, wherein preferably the aqueous formulation is obtainable or obtained by a process comprising combining one or more slurries comprising the at least one pigment and/or the at least one filler, more preferably comprising the at least one pigment and the at least one filler, with an aqueous polymer dispersion according to any one of embodiments 45 to 52.
56. The aqueous formulation of embodiment 54 or 55, further comprising one or more of wetting agents or dispersants, filming auxiliaries, thickeners, leveling agents, biocides, defoamers and curing catalysts.
57. A process for preparing an aqueous formulation, preferably the aqueous formulation according to any one of embodiments 54 to 56, the process comprising
   (I) providing one or more slurries comprising at least one pigment and/or at least one filler, preferably comprising at least one pigment and at least one filler;
   (II) combining the one or more slurries provided according to (I) with an aqueous polymer dispersion according to any one of embodiments 45 to 52.
58. The process of embodiment 57, wherein (I) comprises
   (I.1) mixing one or more powders comprising the at least one pigment with one or more powders comprising the at least one filler, obtaining one or more powder mixtures;
   (I.2) adding water to the one or more powder mixtures obtained according to (I.1), obtaining one or more slurries comprising the at least one pigment and the at least one filler.

The present invention is further illustrated by the following second set of embodiments and combinations of embodiments resulting from the dependencies and back-references as indicated. In particular, it is noted that in each instance where a range of embodiments is mentioned, for example in the context of a term such as “The process of any one of embodiments 1′ to 4”, every embodiment in this range is meant to be explicitly disclosed for the skilled person, i.e. the wording of this term is to be understood by the skilled person as being synonymous to “The process of any one of embodiments 1′, 2′, 3′ and 4”. Further, it is explicitly noted that the following set of embodiments represents a suitably structured part of the general description directed to preferred aspects of the present invention, and, thus, suitably supports, but does not represent the claims of the present invention.
1′. A process for preparing an aqueous polymer dispersion having a polymer content of at least 50 weight-% based on the total weight of the aqueous polymer dispersion, the process comprising
   (a) preparing a first aqueous s mixture Y(1) comprising water and a seed latex, wherein the seed latex is an aqueous polymer dispersion exhibiting a monomodal particle size distribution, the polymer particles of the seed latex having an average diameter in the range of from 10 to 100 nm being determined as described in Reference Example 1.2;
   (b) preparing a second aqueous mixture Y(2) comprising water, ethylenically unsaturated monomers which exhibit a Bronsted acidic group, ethylenically unsaturated monomers which do not exhibit a Bronsted acidic group and a base;
   (c) introducing the first aqueous mixture Y(1) according to (a) into a polymerization vessel;
   (d) introducing the second aqueous mixture Y(2) into the polymerization vessel comprising the first aqueous mixture Y(1) according to (a) and subjecting to copolymerization, obtaining said aqueous polymer dispersion;
   wherein the polymer particles of the aqueous polymer dispersion obtained according to (d) exhibit a polymodal particle size distribution;
   wherein at least 95 weight-% of the polymers comprised in the aqueous polymer dispersion are based on the monomers employed according to (b) and (d).
2′. The process of embodiment 1′, wherein the seed latex comprised in the first aqueous mixture Y(1) prepared according to (a) being an aqueous polymer dispersion has a polymer content in the range of from 20 to 50 weight-%, preferably in the range of from 25 to 42 weight-%, based on the total weight of the seed latex.
3′. The process of embodiment 1′ or 2′, wherein the polymer particles of the seed latex have an average diameter in the range of from 10 to 90 nm, preferably in the range of from 15 to 80 nm, more preferably in the range of from 20 to 40 nm, being determined as described in Reference Example 1.2.
4′. The process of any one of embodiments 1′ to 3′, wherein the polymer of the seed latex comprised in the first aqueous mixture Y(1) prepared according to (a) is selected from the group consisting of polystyrene, styrene-acrylate copolymer, polyacrylate and a mixture of two or more thereof, preferably is selected from the group consisting of polystyrene and styrene-acrylate copolymer, more preferably is polystyrene or styrene-acrylate copolymer.
5′. The process of any one of embodiments 1′ to 4′, wherein the first aqueous mixture Y(1) is free of a base.
6′. The process of any one of embodiments 1′ to 5′, wherein the first aqueous mixture Y(1) exhibits a pH in the range of from 6 to 9, preferably in the range of from 7 to 8.5.
7′. The process of any one of embodiments 1′ to 6′, wherein (a) comprises
   (a.1) admixing water and a seed latex under an inert gas atmosphere, wherein the seed latex is an aqueous polymer dispersion exhibiting a monomodal particle size distribution, the polymer particles of the seed latex having an average diameter in the range of from 10 to 100 nm, being determined as described in Reference Example 1.2;
   (a.2) heating the mixture obtained according to (a.1) to a temperature in the range of from 70 to 100° C., preferably in the range of from 80 to 90° C., preferably while stirring;
   wherein (a) preferably consists of (a.1) and (a.2);
   wherein admixing according to (a.1) more preferably is performed at a temperature in the range of from 15 to 35° C., more preferably in the range of from 18 to 30° C., more preferably in the range of from 20 to 25° C.
8′. The process of any one of embodiments 1′ to 7′, wherein the ethylenically unsaturated monomers which exhibit a Bronsted acidic group comprised in the second mixture Y(2) prepared according to (b) are selected from the group consisting of monoethylenically unsaturated monocarboxylic acids having 3 to 6 carbon atoms, monoethylenically unsaturated dicarboxylic acids having 4 to 6 carbon atoms, monoethylenically unsaturated sulfonic acids, monoethylenically unsaturated phosphonic acids, monoethylenically unsaturated phosphoric acids and a mixture of two or more thereof, preferably are monoethylenically unsaturated monocarboxylic acids having 3 to 6 carbon atoms or monoethylenically unsaturated monocarboxylic acids having 3 to 6 carbon atoms and monoethylenically unsaturated sulfonic acids;
   wherein the total amount of monomers which exhibit a Bronsted acidic group comprised in the second aqueous mixture Y(2) prepared according to (b) is preferably in the range of from 0.5 to 5 pphm, more preferably in the range of from 1 to 3 pphm based on the total amount of monomers comprised in the second aqueous mixture Y(2).
9′. The process of embodiment 8′, wherein the monoethylenically unsaturated monocarboxylic acid having 3 to 6 carbon atoms is one or more of methacrylic acid, acrylic acid, crotonic acid, 2-ethylpropenoic acid, 2-propylpropenoic acid, 2-acryloxyacetic acid and 2-methacyloxyacetic acid, preferably one or more of methacrylic acid and acrylic acid, more preferably methacrylic acid or acrylic acid; and
   wherein the monoethylenically unsaturated sulfonic acid is one or more of 2-acrylamido-2-methylpropane sulfonic acid (AMPS), vinylsulfonic acid, allylsulfonic acid, sulfoethyl methacrylate, sulfopropyl methacrylate and styrenesulfonic acid, more preferably one or more of AMPS and vinylsulfonic acid more preferably AMPS.
10′. The process of embodiment 8′, wherein the monoethylenically unsaturated dicarboxylic acid having 4 to 6 carbon atoms is one or more of itaconic acid, maleic acid and fumaric acid.
11′. The process of any one of embodiments 1′ to 10′, wherein the monomers which do not exhibit a Bronsted acidic group comprised in the second aqueous mixture prepared according to (b) comprises one or more of C₁-C₂₀ alkyl esters of acrylic acid, C₁-C₂₀ alkyl esters of methacrylic acid, C₅-C₂₀ cycloalkyl esters of acrylic acid, C₅-C₂₀ cycloalkyl esters of methacrylic acid, C₅-C₂₀ cycloalkylmethyl esters of acrylic acid, C₅-C₂₀ cycloalkylmethyl esters of methacrylic acid, wherein the cycloalkyl in the aforementioned monomers is mono-, bi- or tricyclic and wherein 1 or 2 nonadjacent CH₂ moieties of the cycloalkyl may be replaced by oxygen atoms and wherein the cycloalkyl may be unsubstituted or carry 1, 2, 3 or 4 methyl groups, and vinylaromatic monomers, wherein preferably the monomers which do not exhibit a Bronsted acidic group comprised in the aqueous monomer mixture used in (b) comprises C₁-C₂₀ alkyl esters of acrylic acid and vinylaromatic monomers.
12′. The process of embodiment 11′, wherein the C₁-C₂₀ alkyl ester of acrylic acid is selected from the group consisting of methyl acrylate, ethyl acrylate, n-propyl acrylate, isopropylacrylate, n-butyl acrylate, 2-butyl acrylate, isobutyl acrylate, tert-butyl acrylate, n-pentyl acrylate, isoamyl acrylate, n-hexyl acrylate, n-octyl acrylate, 2-octyl acrylate, 2-ethylhexyl acrylate, n-decyl acrylate, 2-propylheptyl acrylate, lauryl acrylate, C12/C14-alkyl acrylate, and a mixture of two or more thereof, preferably selected from the group consisting of n-butyl acrylate, iso-butyl acrylate, tert-butyl acrylate, 2-octyl acrylate, 2-ethylhexyl acrylate, and a mixture of two or more thereof, more preferably is selected from the group consisting of n-butyl acrylate, 2-ethylhexyl acrylate and a mixture thereof;
   wherein the total amount of C₁-C₂₀ alkyl esters of acrylic acid in the mixture Y(2) preferably is in the range of 20 to 80 pphm, preferably in the range of from 30 to 50 pphm, more preferably in the range of from 40 to 48 pphm based on the total amount of monomers comprised in the second aqueous mixture Y(2).
13′. The process of embodiment 11′, wherein the vinylaromatic monomer is a mono-vinyl substituted aromatic hydrocarbons selected from the group consisting of styrene, 2-methylstyrene, 4-methylstyrene, 2-n-butylstyrene, 4-n-butylstyrene, 4-n-decylstyrene, α-methylstyrene and a mixture of two or more thereof, preferably selected from the group consisting of styrene, 4-methylstyrene and α-methylstyrene, more preferably styrene; wherein the total amount of the vinylaromatic monomers in the mixture Y(2) is preferably in the range of 30 to 69.5 pphm, more preferably in the range of from 35 to 59 pphm based on the total amount of monomers comprised in the second aqueous mixture Y(2).
14′. The process of any one of embodiments 1′ to 13′, wherein, in the second aqueous mixture Y(2) prepared according to (b), the degree of neutralization of the monomers which exhibit a Bronsted acidic group is in the range of from 5 to 250%, more preferably in the range of from 10 to 200%, more preferably in the range of from 15 to 150%, the degree of neutralization being determined by the molar ratio of the amount of base to the amount of carboxylic acid functionalities.
15′. The process of any one of embodiments 1′ to 14′, wherein, in the second aqueous mixture Y(2) prepared according to (b), the molar ratio of the base to the Bronsted acidic group of the monomers which exhibit a Bronsted acidic group is in the range of from 0.05:1 to 2.5:1, more preferably in the range of from 0.10:1 to 2:1, more preferably in the range of from 0.15:1 to 1.5:1.
16′. The process of any one of embodiments 1′ to 15′, wherein Tg(Y(2)) is in the range of from −10 to 40° C., preferably in the range of from −5 to 30° C., more preferably in the range of from −5 to 9° C., more preferably in the range of from 0 to 8° C., or more preferably in the range of from 10 to 30° C., more preferably in the range of from 12 to 25° C., Tg(Y(2)) being the theoretical glass transition temperature (Tg) of the polymer which would be obtained from polymerization of the monomers of the mixture Y(2), wherein said theoretical glass transition temperatures Tg(Y(2)) is determined according to the Fox equation.
17′. The process of any one of embodiments 1′ to 16′, wherein the base comprised in the second aqueous mixture Y(2) prepared according to (b) is selected from the group consisting of sodium hydroxide, ammonium hydroxide, sodium carbonate, ammonium bicarbonate, potassium hydroxide, calcium hydroxide, sodium bicarbonate, preferably selected from the group consisting of sodium hydroxide, ammonium hydroxide and potassium hydroxide, more preferably is sodium hydroxide.
18′. The process of any one of embodiments 1′ to 17′, wherein the second aqueous mixture Y(2) further comprises monoethylenically unsaturated silane functional monomers, said monoethylenically unsaturated silane functional monomers are preferably monomers which in addition to an ethylenically unsaturated double bond bear at least one mono-, di- and/or tri-C1-C4-alkoxysilane group, wherein the monoethylenically unsaturated silane functional monomer is more preferably one or more of vinyl triethoxysilane (VTEO), 3-methacryloxypropyl trimethoxysilane (MEMO), vinyl trimethoxysilane, methacryloxymethyl trimethoxysilane and methacryloxymethyl triethoxysilane, more preferably one or more of vinyl triethoxysilane (VTEO) and 3-methacryloxypropyl trimethoxysilane (MEMO), more preferably 3-methacryloxypropyl trimethoxysilane (MEMO) or vinyl triethoxysilane (VTEO).
19′. The process of any one of embodiments 1′ to 18′, wherein the second aqueous mixture Y(2) further comprises one or more surfactants, wherein the surfactants are each selected from the group consisting of an anionic surfactant, a non-ionic surfactant and a mixture thereof,
   wherein the anionic surfactant preferably comprises at least one anionic group, which is more preferably selected from the group consisting of a phosphate group, a phosphonate group, a sulfate group and a sulfonate group;
   wherein preferably from 0 to 5 weight-%, more preferably from 0.1 to 3 weight-%, more preferably from 0.2 to 2 weight-%, of the the second aqueous mixture Y(2) consist of the one or more surfactants.
20′. The process of embodiment 19′, wherein the surfactant is an anionic surfactant, being preferably an anionic emulsifier comprising at least one a sulfate group or a sulfonate group, more preferably a sulfate group.
21′. The process of embodiment 20′, wherein the anionic emulsifier comprising a sulfate group is a salt of alkyl sulfates or alkyl ether sulfates, more preferably C8-C22-alkyl sulfates or alkyl ether sulfates.
22′. The process of any one of embodiments 1′ to 21′, further comprising introducing a third aqueous mixture Y(3) into the polymerization vessel comprising the first aqueous mixture Y(1), wherein the third aqueous mixture Y(3) comprises water and an initiator.
23′. The process of embodiment 22′, wherein the initiator is a free-radical initiator, being preferably inorganic peroxide, more preferably peroxodisulfate salt, more preferably sodium peroxodisulfate.
24′. The process of embodiment 22′ or 23′, wherein the amount of the initiator comprised in the third aqueous mixture Y(3) is in the range of from 0.1 to 1 weight-%, preferably in the range of from 0.25 to 0.80 weight-%, based on the total amount of monomers comprised in the second aqueous mixture Y(2).
25′. The process of any one of embodiments 1′ to 24′, wherein according to (d) the second aqueous mixture Y(2) is introduced continuously into the polymerization vessel as a first feed.
26′. The process of embodiment 25′, wherein the first feed is introduced continuously at a constant feed rate.
27′. The process of embodiment 25′, wherein the first feed is introduced into the polymerization vessel according to (d) at different feed rates, F1-Fx, with x=2 or more, wherein F1<Fx, wherein the feed rates are >0 g/h.
28′. The process of any one of embodiments 1′ to 27′, wherein introducing the second aqueous mixture Y(2) into the polymerization vessel according to (d) is performed for a period in the range of from 90 to 350 minutes, preferably in the range of from 100 to 320 minutes.
29′. The process of any one of embodiments 21′ to 23′, and any one of embodiments 27 to 31 as far as it depends on any one of embodiments 24 to 26, wherein the third aqueous mixture Y(3) is introduced continuously into the polymerization vessel as a second feed.
30′. The process of embodiment 29′, wherein the second feed is introduced into the polymerization vessel at different feed rates, F1-Fx, with x=2 or more, preferably 2, in g/h, wherein the feed rates are >0 g/h, wherein F1<Fx.
31′. The process of embodiment 29′ or 30′, wherein introducing the third aqueous mixture Y(3) into the polymerization vessel is performed for a period in the range of from 150 to 400 minutes, preferably in the range of from 175 to 330 minutes.
32′. The process of any one of embodiments 1′ to 31′, wherein introducing the second aqueous mixture Y(2) according to (d) is performed at a time T(M) and introducing the third aqueous mixture Y(3) as defined in any one of embodiments 18′ to 20′ is performed at a time T(I), wherein T(M)≤T(I), preferably T(M)+3 min≤T(I), more preferably T(M)+5 min≤T(I).
33′. The process of any one of embodiments 1′ to 32′, wherein the second aqueous mixture Y(2) is an emulsion.
34′. The process of any one of embodiments 1′ to 33′, wherein from 98 to 100 weight-%, preferably from 99 to 100 weight-%, more preferably from 99.5 to 100 weight-%, more preferably from 99.9 to 100 weight-%, of the second aqueous mixture Y(2) consist of water, the ethylenically unsaturated monomers which exhibit a Bronsted acidic group, the ethylenically unsaturated monomers which do not exhibit a Bronsted acidic group, the base and one or more surfactants as defined in any one of embodiments 14′ to 17′.
35′. The process of any one of embodiments 1′ to 34′, wherein co-polymerization into the polymerization vessel according (d) is conducted at a temperature in the range of from 70 to 100° C., preferably in the range of from 80 to 90° C. 536′. The process of any one of embodiments 1 to 35′, further comprising introducing a seed latex, preferably a polystyrene aqueous dispersion, at a time T(S) into the polymerization vessel, wherein T(S) starts when at least 5 weight-%, preferably at least 10 weight-%, more preferably at least 15 weight-%, more preferably from 15 to 70 weight-%, more preferably from 20 to 60 weight-%, of the aqueous mixture Y(2) have been introduced into the polymerization vessel.
37′. The process of any one of embodiments 1 to 35′, wherein no seed latex is further introduced in the polymerization vessel comprising the second aqueous mixture Y(2).
38′ The process of embodiment 37′, further comprising introducing a surfactant, preferably as defined in any one of embodiments 17′, 19′ and 20′, at a time T(E) into the polymerization vessel, wherein T(e) starts when at least 2 weight-%, preferably at least 3 weight-%, more preferably from 3 to 60 weight-%, more preferably from 3 to 10 weight-% or more preferably from 40 to 60 weight-%, of the aqueous mixture Y(2) have been introduced into the polymerization vessel. 20
39′. The process of any one of embodiments 1′ to 38′, wherein from 95 to 100 weight-%, preferably from 98 to 100 weight-%, of the polymers comprised in the aqueous polymer dispersion are based on the monomers employed according to (b) and (d).
40′. The process of any one of embodiments 1′ to 39′, further comprising
   (e) introducing water and one or more additives into the polymerization vessel, wherein preferably each additive is selected from the group consisting of an oxidative agent and a reductive agent;
      wherein the oxidative agent is preferably hydroperoxide, more preferably one or more of hydrogen peroxide, t-butyl hydroperoxide, isoamyl hydroperoxide, isoamyl hydroperoxide and cumene hydroperoxide, more prefereably t-butyl hydroperoxide; wherein the reductive agent is preferably one or more of ascorbic acid, its Na salt, isoascorbic acid, its Na salt, sulfite and its adducts to aldehydes and ketones; wherein (e) more preferably comprises introducing water, ascorbic acid and t-butyl 35 hydroperoxide.
41′. The process of any one of embodiments 1′ to 40′, having an overall duration in the range of from 180 to 500 minutes, preferably in the range of from 200 to 450 minutes, more preferably in the range of from 210 to 420 minutes.
42′. The process of any one of embodiments 1′ to 41′, consisting of (a), (b), (c), (d) and preferably (e).
43′. An aqueous polymer dispersion obtainable or obtained by a process according to any one of embodiments 1′ to 42′, said dispersion having a polymer content of at least 50 weight-% based on the total weight of the aqueous polymer dispersion, wherein the polymer particles of the aqueous polymer dispersion exhibit a polymodal particle size distribution.
44′. The aqueous polymer dispersion of embodiment 43′, having a polymer content of at least 55 weight-%, preferably in the range of from 55 to 75 weight-%, more preferably in the range of from 60 to 70 weight-%, preferably being determined as described in Reference Example 1.2.
45′. The aqueous polymer dispersion of embodiment 43′ or 44′, having a bimodal particle size distribution.
46′. The aqueous polymer dispersion of embodiment 45′, having a bimodal particle size distribution such that X weight-% of the particles of the dispersion have a diameter in the range of from 40 to 150 nm, preferably from 50 to 125 nm, and Y weight-% of the particles of the dispersion have a diameter in the range of 180 to 400 nm, preferably in the range of from 200 to 350 nm, wherein Y=100-X.
47′. The aqueous polymer dispersion of embodiment 46′, wherein X is in the range of from 5 to 40, preferably in the range of from 10 to 37, more preferably in the range of from 15 to 35.
48′. The aqueous polymer dispersion of any one of embodiment 43′ to 47′, having a pH in the range of from 5 to 9, preferably in the range of from 6 to 8.5, more preferably in the range of from 6.5 to 8.
49′. The aqueous polymer dispersion of any one of embodiments 43′ to 48′, having a viscosity of at most 2500 mPas, preferably at most 2000 mPas, wherein the viscosity is more preferably in the range of from 100 to 2000 mPas, more preferably in the range of from 200 to 1500 mPas, the viscosity being determined as described in Reference Example 1.3.
50′. The aqueous polymer dispersion of any one of embodiments 43′ to 49′, having a fine coagulum, defined in μg of coagulate particles per gram of the aqueous dispersion, which is of at most 7500 μg/g, preferably of at most 2500 μg/g, more preferably of at most 2200 μg/g, more preferably in the range of from 50 to 2200 μg/g, the fine coagulum being determined as described in Reference Example 1.5.
51′. Use of an aqueous polymer dispersion according to any one of embodiments 43′ to 50′ in an aqueous formulation for one or more of coating, sealant and adhesive bonding, preferably the aqueous formulation being for coating, sealant and adhesive bonding.
52′. An aqueous formulation for one or more of coating, sealant and adhesive bonding, preferably for coating, sealant and adhesive bonding, the aqueous formulation comprising an aqueous polymer dispersion according to any one of embodiments 43′ to 50′, wherein the polymer content originating from the aqueous dispersion is in the range of from 5 to 90 weight-% based on the total weight content of the aqueous formulation.
53′. The aqueous formulation of embodiment 52′, further comprising at least one pigment and/or at least one filler, wherein preferably the aqueous formulation is obtainable or obtained by a process comprising combining one or more slurries comprising the at least one pigment and/or the at least one filler, more preferably comprising the at least one pigment and the at least one filler, with an aqueous polymer dispersion according to any one of embodiments 43′ to 50′.
54′. The aqueous formulation of embodiment 52′ or 53′, further comprising one or more of wetting agents or dispersants, filming auxiliaries, thickeners, leveling agents, biocides, defoamers and curing catalysts.
55′. A process for preparing an aqueous formulation, preferably the aqueous formulation according to any one of embodiments 52′ to 54′, the process comprising
   (A) providing one or more slurries comprising at least one pigment and/or at least one filler, preferably comprising at least one pigment and at least one filler;
   (B) combining the one or more slurries provided according to (A) with an aqueous polymer dispersion according to any one of embodiments 43′ to 50′.
56′. The process of embodiment 55′, wherein (A) comprises
   (A.1) mixing one or more powders comprising the at least one pigment with one or more powders comprising the at least one filler, obtaining one or more powder mixtures;
   (A.2) adding water to the one or more powder mixtures obtained according to (A.1), obtaining one or more slurries comprising the at least one pigment and the at least one filler.

In the context of the present invention, it is noted that the glass transition temperature of the polymer dispersion particles is governed by the monomer composition and thus by composition of the monomers to be polymerized. Therefore, by choosing proper amounts of monomers in the second aqueous mixture X(2) and Y(2), the glass transition temperature of the polymer to be obtained can be adjusted. According to T. G. Fox, Bulletin of the American Physical Society 1, page 123 (1956 [Ser. II]) and according to Ullmann's Encyclopedia of Industrial Chemistry (vol. 19, page 18, 4^{th} Edition, Verlag Chemie, Weinheim, 1980), the following is a good approximation of the glass transition temperature of no more than lightly cross-linked copolymers:

$$1 / Tg = {x}_{1} / {Tg}_{1} + {x}_{2} / {Tg}_{2} + … {x}_{n} / {Tg}_{n} ,$$

where x₁, x₂, . . . xₙ are the mass fractions of the monomers 1, 2, . . . n and Tg₁, Tg₂, . . . . Tgₙ are the glass transition temperatures in Kelvin of the polymers synthesized from only one of the monomers 1, 2, . . . n at a time. The Tg values for the homopolymers of most monomers are known and listed, for example, in J. Brandrup, E. H. Immergut, Polymer Handbook, 1^{st} Edition—J. Wiley, New York 1966, 2^{nd} Edition—J. Wiley, New York 1975, and 3^{rd} Edition—J. Wiley, New York 1989.

For the sake of clarity, the following table displays the theoretical glass transition temperatures of homopolymers that have been used for the calculation of this invention's copolymers employing the Fox equation:

| | Tg | | |
|---|---|---|---|
| Monomer | (homopolymer) | | Source |
| ethyl acrylate | −8° | C. | Tsavalas¹ |
| n-butyl acrylate | −40° | C. | Tsavalas |
| 2-ethylhexyl acrylate | −60° | C. | Tsavalas |
| 2-octyl acrylate | −40° | C. | own DSC measurements |
| n-butyl methacrylate | +35° | C. | Tsavalas |
| methyl methacrylate | +119° | C. | Tsavalas |
| styrene | +104° | C. | Tsavalas |
| methacrylic acid | +185° | C. | Tsavalas |
| acrylic acid | +103° | C. | Tsavalas |
| diacetone acrylamide | +85° | C. | supplier² |
| isobutyl acrylate | −24° | C. | Brandrup⁴ |
| 2-acrylamido-2- | 124° | C. | own DSC measurements |
| methylpropane sulfonic | | | |
| acid | | | |
| 3-methacryloxypropyl tri- | +55° | C. | own DSC measurements |
| methoxysilane | | | |
| vinyl triethoxysilane | +90° | C. | own DSC measurements |
| Plex ® (=25 wt. % | +85° | C. | own DSC measurement |
| ureidoethyl methacrylate | | | on copolymer with MMA³ |
| in MMA) | | | |
| acetoacetoxyethyl | +8° | C. | own DSC measurement |
| methacrylate | | | |
| Sipomer ® PAM-200 | 0° | C. | own DSC measurement |
| Sipomer ® PAM-4000 | +149° | C. | calculated from examples |
| | | | 4 + 5 in US 2014/0141188 |

¹Tsavalas et al. Langmuir 2010, 26(10), 6960-6966
²https://www.gantrade.com/blog/daam-vs-adh
³calculated using the Tg value of UMA-MMA-copolymer determined by DSC, wherein the co-polymer consists of 50 wt. % of Plex ® and 50 wt. % of MMA with respect to the total weight of the copolymer
⁴Brandrup, J.; Immergut, E. H.; Grulke, E. A.; Polymer Handbook, 4th Edition, Wiley, New York, 1999

“pphm” refers to parts per hundred monomers, this permits to evaluate the amount of a given monomer in a monomer mixture relative to 100 parts of monomers forming the monomer mixture.

The present invention is further illustrated by the Examples below.

### EXAMPLES

### Reference Example 1 Analytics

### 1.1 Solid Content

The solid content was determined by drying a defined amount of the aqueous polymer dispersion (about 2 g) to constant weight in an aluminum crucible having an internal diameter of about 5 cm at 130° C. in a drying cabinet (2 hours). The ratio of the mass after drying to the mass before drying gave the solids content of the polymer latex. Two separate measurements were conducted. The value reported in the example is the mean of the two measurements.

### 1.2 Particle Size/Particle-Size Distribution (PSD)

The weight-average particle diameter of the polymer latices was determined by hydrodynamic fractionation techniques (HDC). Measurements were carried out using a PL-PSDA particle size distribution analyzer (Polymer Laboratories, Inc.). A small amount of sample of the polymer latex of interest was injected into an aqueous eluent containing an emulsifier, resulting in a concentration of approximately 0.5 g/l. The mixture was pumped through a glass capillary tube of approximately 15 mm diameter packed with polystyrene spheres. As determined by their hydrodynamic diameter, smaller particles can sterically access regions of slower flow in capillaries, such that on average the smaller particles experience slower elution flow. The fractionation was finally monitored using an UV detector which measured the extinction at a fixed wavelength of 254 nm. To estimate particle sizes from the elution time, a calibration with particles of well-known size is necessary. For this calibration, a series of differently sized particles (where the exact mean diameter is known) is measured and the elution time recorded. Ideally, the calibration particles span a size range much broader than the experimental particles. Based on this calibration, the measured UV signal along the elution time can be calculated back to the respective size of the analyzed particle mixture. In practice, for a bimodal particle size distribution, a fit of two Gaussian distributions is made to the UV signal and the HDC mean taken as the weight-averaged mean-value of the particle size. For unimodal distributions one Gaussian is taken and for polymodal distributions the number of individual peaks, respectively.

HDC peak denominates the peak maximum/peak maxima in particle-size distribution; sometimes also called “HDC mode”.

### 1.3 Viscosity

Viscosity was measured at 20° C. according to the standard method DIN EN ISO 3219:1994 using a “Brookfield RV”-type laboratory viscosimeter employing spindles #4 or #5 at 100 revolutions per minute.

### 1.4 Coarse Coagulum Formed During Polymerization (>125 μm)

After completion of the polymerization the obtained polymer dispersion was filtered through a nylon filter with a 125 μm mesh size and the solid filter content was weighed. The weight of the filter content in relation to total mass of obtained wet polymer dispersion gave the proportion of coagulum in % by weight (wet/wet).

### 1.5 Fine Coagulum Formed During Polymerization (>10 μm)

Measurement of the amount of fine coagulum in the dispersion was conducted similar to the measurement of the particle size distribution with the exception that the particle size distribution of the coarser particles (>10 μm) was measured by the light scattering method. Production of coagulates with particle sizes above 10 μm is an indication of colloidal instability. All values are given in μg of coagulate particles per gram of dispersion.

### 1.6 Film Homogeneity

For evaluation of film homogeneity, the crude dispersion was cast onto a glass plate with a wet film thickness of 120 μm. Immediately after casting, film homogeneity was assessed optically on a 1 to 5 scale as follows (the lowest applicable grade was given):
1: no defects visible
2: less than 1 defect on average per cm²
3: less than 5 defects on average per cm² (more than 1 defect)
4: less than 10 defects on average per cm² (more than 5 defects)
5: more than 10 defects on average per cm²

Emulsifier solution 1: Sodium salts of fatty alcohol C₁₂-C₁₄ ethoxylated sulfate sodium salt in water, solids content: 28 weight-% based on the total weight of the emulsifier solution.

Emulsifier solution 2: Sodium salt of an ethoxylated alkylphenol sulfate, bearing a C9 alkyl chain and 25 EO repeating units on average, solids content: 31 weight-% based on the total weight of the emulsifier solution.

Emulsifier solution 3: Ethoxylated alkylphenol, bearing a C8 alkyl chain and 25 EO repeating units on average, solids content: 20 weight-% based on the total weight of the emulsifier solution.

### Example 1

A polymerization vessel equipped with metering units and closed-loop temperature control was initially charged at 20 to 25° C. (room temperature) under a nitrogen atmosphere with 184.11 g of deionized water 5.83 g sodium bicarbonate and 1.06 g of seed latex (Polystyrene, 30 nm) and heated to 85° C. while stirring. On attainment of this temperature, 9.68 g of feed 2 were added and the mixture was stirred at 85° C. for further 5 min. Then, while maintaining the temperature, simultaneously feed 1 and the remainder of feed 2 were started. 324.12 g of Feed 1 was metered at constant feed rate into the reaction within 150 min. and feed 2 was metered at constant feed rate into the reaction vessel within 315 min., while stirring was continued and the temperature of 85° C. was maintained. After 150 min addition 1 was added and the remaining 583.49 g of feed 1 was metered at constant feed rate into the reaction within 135 min. After having metered feed 2 completely into the reaction vessel, rinse water 1 was added and stirring at 85° C. was continued for 30 min. Then, feed 3 and feed 4 were started simultaneously and metered into the reaction vessel within 60 minutes while maintaining the temperature of 85° C. Afterwards, rinse water 2 was added. The obtained polymer latex was cooled to ambient temperature and filtered through a 125 μm filter.

Thereby, around 1150 g of an aqueous polymer latex was obtained. The solid content of the dispersion was 61.6%, 0.3 wt.-% coagulum (dry on dispersion) and the pH was found to be 7.1. The aqueous polymer dispersion diluted with deionized water had a bimodal particle size distribution with populations at 120 nm (26 weight-%) and 300 nm (74 weight-%) and a viscosity of 228 mPas.

### Precharge

### Mixture X(1)

| | |
|---|---|
| 143.41 g | deionized water |
| 1.06 g | seed latex (polystyrene, 30 nm, at 33 wt.-% solids) |
| 5.83 g | sodium bicarbonate |

### Feed 1 (Emulsion of):

### Mixture X(2)

| | |
|---|---|
| 146.15 g | deionized water |
| 12.50 g | emulsifier solution 1 |
| 370.65 g | styrene |
| 318.85 g | n-Butyl acrylate |
| 10.50 g | methacrylic acid |
| 49.00 g | sodium hydroxide (10 wt.-%) |

### Addition 1:

| | |
|---|---|
| 6.36 g | seed latex (polystyrene, 30 nm, at 33 wt.-% solids) |

### Feed 2

### Mixture X(3)

| | |
|---|---|
| 44.00 g | sodium peroxodisulfate (7 wt.-% in water) |

Rinse water 1

| | |
|---|---|
| 11.97 g | deionized water |

### Feed 3

| | |
|---|---|
| 14.00 g | 10% by weight aqueous solution of tert-butyl hydroperoxide |

### Feed 4

| | |
|---|---|
| 14.00 g | 10% by weight aqueous solution of ascorbic acid |

Rinse water 2

| | |
|---|---|
| 5.20 g | deionized water |

### Example 2

For this example, the precharge, Feed 1, addition 1, Feed 2, rinse water 1, Feed 3, Feed 4, rinse water 2 are the same as in Example 1. A polymerization vessel equipped with metering units and closed-loop temperature control was initially charged at 20 to 25° C. (room temperature) under a nitrogen atmosphere with 184.11 g of deionized water 5.83 g sodium bicarbonate and 1.06 g of seed latex (Polystyrene, 30 nm, at 33 wt.-% solids) and heated to 85° C. while stirring. On attainment of this temperature, 9.68 g of feed 2 were added and the mixture was stirred at 85° C. for further 5 min. Then, while maintaining the temperature, simultaneously Feed 1 and the remainder of Feed 2 were started. 126.77 g of Feed 1 was metered at constant feed rate into the reaction within 60 min, followed by 188.78 g of Feed 1 within 30 min at constant feed rate, followed by 126.77 g of Feed 1 within 60 min at constant feed rate, followed by 442.32 g within 105 min at constant feed rate. Feed 2 was metered at constant feed rate into the reaction vessel within 285 min., while stirring was continued and the temperature of 85° C. was maintained. 150 min after start of Feed 1 and Feed 2 addition 1 was added. After having metered Feed 2 completely into the reaction vessel, rinse water 1 was added and stirring at 85° C. was continued for 30 min. Then, feed 3 and feed 4 were started simultaneously and metered into the reaction vessel within 60 minutes while maintaining the temperature of 85° C. Afterwards, rinse water 2 was added. The obtained polymer latex was cooled to ambient temperature and filtered through a 125 μm filter.

Thereby, around 1120 g of an aqueous polymer latex was obtained. The solid content of the dispersion was 62.6%, 0.3 wt.-% coagulum (dry on dispersion) and the pH was found to be 7.4. The aqueous polymer dispersion diluted with deionized water had a bimodal particle size distribution with populations at 115 nm (17 weight-%) and 314 nm (83 weight-%) and a viscosity of 844 mPas.

### Example 3

A polymerization vessel equipped with metering units and closed-loop temperature control was initially charged at 20 to 25° C. (room temperature) under a nitrogen atmosphere with 134.40 g of deionized water 5.83 g sodium bicarbonate and 1.27 g of seed latex (Polystyrene, 30 nm) and heated to 85° C. while stirring. On attainment of this temperature, 10.0 g of feed 2 were added and the mixture was stirred at 85° C. for further 5 min. Then, while maintaining the temperature, simultaneously Feed 1 and the remainder of Feed 2 were started. Feed 1 was metered at constant feed rate into the reaction within 165 min. Feed 2 was metered at constant feed rate into the reaction vessel within 195 min., while stirring was continued and the temperature of 85° C. was maintained. After having metered Feed 2 completely into the reaction vessel, rinse water 1 was added and stirring at 85° C. was continued for 30 min. Then, feed 3 and feed 4 were started simultaneously and metered into the reaction vessel within 60 minutes while maintaining the temperature of 85° C. Afterwards, rinse water 2 was added. The obtained polymer latex was cooled to ambient temperature and filtered through a 125 μm filter.

Thereby, around 1120 g of an aqueous polymer latex was obtained. The solid content of the dispersion was 60.6%, 0.1 wt.-% coagulum (dry on dispersion) and the pH was found to be 7.6. The aqueous polymer dispersion diluted with deionized water had a bimodal particle size distribution with populations at 58 nm (21 weight-%) and 230 nm (79 weight-%) and a viscosity of 310 mPas.

### Precharge

### Mixture X(1)

| | |
|---|---|
| 134.40 g | deionized water |
| 1.27 g | seed latex (polystyrene, 30 nm, at 33 wt.-% solids) |
| 5.83 g | sodium bicarbonate (6 wt.-% solution in water) |

### Feed 1 (Emulsion of):

### Mixture X(2)

| | |
|---|---|
| 149.93 g | deionized water |
| 26.75 g | emulsifier solution 1 |
| 370.65 g | styrene |
| 318.85 g | n-Butyl acrylate |
| 10.50 g | methacrylic acid |
| 49.00 g | sodium hydroxide (10 wt.-%) |

### Feed 2

### Mixture X(3)

| | |
|---|---|
| 60.00 g | sodium peroxodisulfate (7 wt.-% in water) |

Rinse water 1

| | |
|---|---|
| 11.97 g | deionized water |

### Feed 3

| | |
|---|---|
| 14.00 g | 10% by weight aqueous solution of tert-butyl hydroperoxide |

### Feed 4

| | |
|---|---|
| 9.10 g | 10% by weight aqueous solution of ascorbic acid |

### Example 4

The reaction was conducted according to Example 1, with the exception that 11.67 g of a tetrasodium pyrophosphate solution (3 wt.-% in water) was used instead of sodium bicarbonate in the precharge.

### Precharge

### Mixture X(1)

| | |
|---|---|
| 143.41 g | deionized water |
| 1.06 g | seed latex (polystyrene, 30 nm, at 33 wt.-% solids) |
| 11.67 g | tetrasodium pyrophosphate solution (3 wt.-% in water) |

The solid content of the dispersion was 61.7%, 0.2 wt.-% of coarse coagulum, about 200 μg/g of fine coagulum and the pH was found to be 7.2. The aqueous polymer dispersion diluted with deionized water had a bimodal particle size distribution with populations at 109 nm (26 weight-%) and 308 nm (74 weight-%) and a viscosity of 426 mPas.

### Example 5

The reaction was conducted according to Example 1, with the exception that 11.67 g of a tetrasodium pyrophosphate solution (3 wt.-% in water) was used instead of sodium bicarbonate in the precharge and the amount of sodium hydroxide solution (10 wt.-%) in feed 1 was reduced from 49 g to 9.8 g.

### Precharge

### Mixture X(1)

| | |
|---|---|
| 143.41 g | deionized water |
| 1.06 g | seed latex (polystyrene, 30 nm, at 33 wt.-% solids) |
| 11.67 g | tetrasodium pyrophosphate solution (3 wt.-% in water) |

The solid content of the dispersion was 61.8%, 0.3 wt.-% of coarse coagulum, about 300 μg/g of fine coagulum and the pH was found to be 7.1. The aqueous polymer dispersion diluted with deionized water had a bimodal particle size distribution with populations at 96 nm (19 weight-%) and 309 nm (81 weight-%) and a viscosity of 300 mPas.

### Example 6

The reaction was conducted according to Example 1, with the exception that 5.83 g of an ammonium bicarbonate solution (6 wt.-% in water) was used instead of sodium bicarbonate in the precharge.

### Precharge

### Mixture X(1)

| | |
|---|---|
| 143.41 g | deionized water |
| 1.06 g | seed latex (polystyrene, 30 nm, at 33 wt.-% solids) |
| 5.83 g | ammonium bicarbonate solution (6 wt.-% in water) |

The solid content of the dispersion was 62%, 0.2 wt.-% of coarse coagulum, about 500 μg/g of fine coagulum and the pH was found to be 7.2. The aqueous polymer dispersion diluted with deionized water had a bimodal particle size distribution with populations at 102 nm (28 weight-%) and 298 nm (72 weight-%) and a viscosity of 553 mPas.

### Example 7

The reaction was conducted according to Example 1, with the exception that 5.83 g of an ammonium bicarbonate solution (6 wt.-% in water) was used instead of sodium bicarbonate in the precharge and the amount of sodium hydroxide solution (10 wt.-%) in feed 1 was reduced from 49 g to 9.8 g.

### Precharge

### Mixture X(1)

| | |
|---|---|
| 143.41 g | deionized water |
| 1.06 g | seed latex (polystyrene, 30 nm, at 33 wt.-% solids) |
| 5.83 g | ammonium bicarbonate solution (6 wt.-% in water) |

The solid content of the dispersion was 61.7%, 0.2 wt.-% of coarse coagulum, about 300 μg/g of fine coagulum and the pH was found to be 7.2. The aqueous polymer dispersion diluted with deionized water had a bimodal particle size distribution with populations at 90 nm (20 weight-%) and 307 nm (80 weight-%) and a viscosity of 328 mPas.

### Comparative Example 1

The synthetic procedure for this comparative example was adapted from Chu et al., Study of Poly(St/BA/MAA) copolymer latexes with bimodal particle size distribution, Polym. Adv. Technol, 9, 851-857 (1998) and was conducted as follows: A polymerization vessel was equipped with metering units and closed-loop temperature control was filled with a precharge (see below) and 2.8 wt.-% of feed 2 and heated to 70° C. while stirring. After stirring the precharge for 30 minutes at 70° C., the temperature was increased to 85° C. On attainment of this temperature, feed 1 and feed 3 were simultaneously started. Feed 1 and 48.6 wt.-% of feed 3 were metered at a constant feed rate into the reaction vessel within 120 minutes while stirring was continued and the temperature of 85° C. maintained. After completion of both feeds, stirring at 85° C. was continued for 30 min and then addition 1 was added into the reaction vessel. Following the addition, feed 2 and the remainder of feed 3 were started and metered at a constant feed rate into the reaction vessel within 75 minutes while stirring was continued and the temperature of 85° C. maintained. After completion of both feeds, stirring at 85° C. was continued for 30 min. The obtained polymer latex was cooled to ambient temperature and filtered through a 125 μm filter.

### Precharge:

| | |
|---|---|
| 137.50 g | deionized water |
| 0.53 g | emulsifier solution 2 |
| 5.78 g | emulsifier solution 3 |
| 8.03 g | n-butyl acrylate |
| 16.23 g | styrene |

### Feed 1 (Emulsion of):

| | | |
|---|---|---|
| 174.02 | g | deionized water |
| 1.95 | g | emulsifier solution 2 |
| 17.60 | g | emulsifier solution 3 |
| 4.95 | g | methacrylic acid |
| 7.15 | g | sodium hydroxide (10 wt.-%) |
| 99.22 | g | n-butyl acrylate |
| 201.58 | g | styrene |

### Addition 1:

| | |
|---|---|
| 77.15 g | seed latex (methacrylic acid/n-butyl acrylate/styrene copolymer, |
| | 109 nm, 50 wt. %) |

### Feed 2 (Emulsion of):

| | | |
|---|---|---|
| 145.04 | g | deionized water |
| 3.55 | g | emulsifier solution 2 |
| 11.00 | g | emulsifier solution 3 |
| 4.40 | g | methacrylic acid |
| 6.05 | g | sodium hydroxide (10 wt.-%) |
| 72.60 | g | n-butyl acrylate |
| 143.00 | g | styrene |

### Feed 3:

| | |
|---|---|
| 56.57 g | sodium persulfate (7 wt.-% in water) |

The solid content of the dispersion was 50.2%, 0.5 wt.-% of coarse coagulum, about 4500 μg/g of fine coagulum and the pH was found to be 5.9. The aqueous polymer dispersion diluted with deionized water had a bimodal particle size distribution with populations at 115 nm (13 weight-%) and 322 nm (87 weight-%) and a viscosity of 100 mPas.

### Comparative Example 2

This reaction was conducted according to Comp. Ex. 1, except that the following feeds were used:

### Precharge:

| | |
|---|---|
| 130.00 g | deionized water |
| 0.63 g | emulsifier solution 2 |
| 6.83 g | emulsifier solution 3 |
| 9.49 g | n-butyl acrylate |
| 19.18 g | styrene |

### Feed 1 (Emulsion of):

| | | |
|---|---|---|
| 96.20 | g | deionized water |
| 2.31 | g | emulsifier solution 2 |
| 20.80 | g | emulsifier solution 3 |
| 5.85 | g | methacrylic acid |
| 8.45 | g | sodium hydroxide (10 wt.-%) |
| 117.26 | g | n-butyl acrylate |
| 238.23 | g | styrene |

### Addition 1:

91.18 g seed latex (methacrylic acid/n-butyl acrylate/styrene copolymer, 109 nm, 50 wt.-%) Feed 2 (emulsion of):

| | | |
|---|---|---|
| 80.15 | g | deionized water |
| 4.19 | g | emulsifier solution 2 |
| 13.00 | g | emulsifier solution 3 |
| 5.20 | g | methacrylic acid |
| 7.15 | g | sodium hydroxide (10 wt.-%) |
| 85.80 | g | n-butyl acrylate |
| 169.00 | g | styrene |

### Feed 3:66.

86 g sodium persulfate (7 wt.-% in water)

The solid content of the dispersion was 59.6%, 1.1 wt.-% of coarse coagulum, about 9500 μg/g of fine coagulum and the pH was found to be 5.9. The aqueous polymer dispersion diluted with deionized water had a bimodal particle size distribution with populations at 127 nm (13 weight-%) and 370 nm (87 weight-%) and a viscosity of 120 mPas.

### Comparative Example 3

This reaction was conducted according to Comp. Ex. 1, except that the following feeds were used:

### Precharge:

| | | |
|---|---|---|
| 126.00 | g | deionized water |
| 0.68 | g | emulsifier solution 2 |
| 7.35 | g | emulsifier solution 3 |
| 10.22 | g | n-butyl acrylate |
| 20.65 | g | styrene |

### Feed 1 (Emulsion of):

| | | |
|---|---|---|
| 70.00 | g | deionized water |
| 2.48 | g | emulsifier solution 2 |
| 22.40 | g | emulsifier solution 3 |
| 6.30 | g | methacrylic acid |
| 9.10 | g | sodium hydroxide (10 wt.-%) |
| 126.28 | g | n-butyl acrylate |
| 256.55 | g | styrene |

### Addition 1:

98.19 g seed latex (methacrylic acid/n-butyl acrylate/styrene copolymer, 109 nm, 50 wt %) Feed 2 (emulsion of):

| | | |
|---|---|---|
| 56.00 | g | deionized water |
| 4.52 | g | emulsifier solution 2 |
| 14.00 | g | emulsifier solution 3 |
| 5.60 | g | methacrylic acid |
| 7.70 | g | sodium hydroxide (10 wt.-%) |
| 92.40 | g | n-butyl acrylate |
| 182.00 | g | styrene |

### Feed 3:

| | |
|---|---|
| 72.00 g | sodium persulfate (7 wt % in water) |

The solid content of the dispersion was 63.9%, 2.4 wt.-% of coarse coagulum, about 15000 μg/g of fine coagulum and the pH was found to be 5.9. The aqueous polymer dispersion diluted with deionized water had a bimodal particle size distribution with populations at 140 nm (16 weight-%) and 433 nm (84 weight-%) and a viscosity of 175 mPas.

### Comparative Example 4

The reaction was conducted according to Example 1, with the exception that no sodium hydroxide solution in feed 1 was used. This dispersion coagulated to such an extent that it could not be brought to completion.

### Example 8

The reaction was conducted according to Example 1, with the exception that no sodium bicarbonate (no base) was added to the precharge.

### Precharge

### Mixture X(1)

| | |
|---|---|
| 143.41 g | deionized water |
| 1.06 g | seed latex (polystyrene, 30 nm, at 33% solids) |

The solid content of the dispersion was 61.3%, 0.3 wt.-% of coarse coagulum, about 200 μg/g of fine coagulum and the pH was found to be 6.5. The aqueous polymer dispersion diluted with deionized water had a bimodal particle size distribution with populations at 110 nm (23 weight-%) and 305 nm (77 weight-%) and a viscosity of 440 mPas.

### Example 9

The reaction was conducted according to Example 1, with the exception that no sodium bicarbonate (no base) was added to the precharge and the amount of sodium hydroxide solution (10 wt.-%) in feed 1 was reduced from 49 g to 9.8 g.

### Precharge

### Mixture X(1)

| | |
|---|---|
| 143.41 g | deionized water |
| 1.06 g | seed latex (polystyrene, 30 nm, at 33% solids) |

The solid content of the dispersion was 62.2%, 0.2 wt.-% of coarse coagulum, about 300 μg/g of fine coagulum and the pH was found to be 7.4. The aqueous polymer dispersion diluted with deionized water had a bimodal particle size distribution with populations at 101 nm (18 weight-%) and 327 nm (82 weight-%) and a viscosity of 344 mPas.

### Example 10

A polymerization vessel equipped with metering units and closed-loop temperature control was initially charged at 20 to 25° C. (room temperature) under a nitrogen atmosphere with 132.90 g of deionized water, 5.83 g sodium bicarbonate and 1.27 g of seed latex (Polystyrene, 30 nm) and heated to 85° C. while stirring. On attainment of this temperature, 10.00 g of feed 2 were added and the mixture was stirred at 85° C. for further 5 min. Then, while maintaining the temperature, simultaneously feed 1 and the remainder of feed 2 were started. Feed 1 was metered at constant feed rate into the reaction within 165 min and feed 2 was metered at constant feed rate into the reaction vessel within 195 min while stirring was continued and the temperature of 85° C. maintained. 85 min after the start of feed 1 addition 1 was added. After having metered feed 2 completely into the reaction vessel, rinse water 1 was added and stirring at 85° C. was continued for 30 min. Then, feed 3 and feed 4 were started simultaneously and metered into the reaction vessel within 60 minutes while maintaining the temperature of 85° C. Afterwards, rinse water 2 was added. The obtained polymer latex was cooled to ambient temperature and filtered through a 125 μm filter.

Thereby, about 1155 g of an aqueous polymer latex was obtained. The solid content of the dispersion was 60.8%, 0.4 wt.-% of coagulum (dry on dispersion) had formed, and the pH was adjusted to 7.0. The aqueous polymer dispersion diluted with deionized water had a bimodal particle size distribution with populations at 106 nm (26 wt.-%) and 298 nm (74 wt.-%) and a viscosity of 375 mPas.

### Precharge

### Mixture X(1)

| | |
|---|---|
| 132.90 g | deionized water |
| 1.27 g | seed latex (polystyrene, 30 nm, 33 wt.-% solids) |
| 5.83 g | sodium bicarbonate (6 wt.-%) |

### Feed 1 (Emulsion of):

### Mixture X(2)

| | | |
|---|---|---|
| 182.71 | g | deionized water |
| 12.88 | g | emulsifier solution 1 |
| 308.73 | g | styrene |
| 286.67 | g | n-butyl acrylate |
| 113.34 | g | 2-ethylhexyl acrylate |
| 10.82 | g | methacrylic acid |
| 1.44 | g | MEMO |
| 10.09 | g | sodium hydroxide (10 wt.-%) |

### Addition 1:

| | |
|---|---|
| 6.36 g | seed latex (polystyrene, 30 nm, 33 wt.-% solids) |

### Feed 2:

### Mixture X(3)

| | |
|---|---|
| 60.00 g | sodium peroxodisulfate (7 wt.-% in water) |

Rinse water 1:

| | |
|---|---|
| 11.97 g | deionized water |

### Feed 3:

| | |
|---|---|
| 14.00 g | tert-butylhydroperoxide (10 wt.-%) |

### Feed 4:

| | |
|---|---|
| 9.10 g | ascorbic acid (10 wt.-%) |

### Example 11

The reaction was conducted according to Example 10, with the exception that the following changes to feed 1 were made:

### Feed 1:

### Mixture X(2)

| | | |
|---|---|---|
| 173.46 | g | deionized water |
| 12.88 | g | emulsifier solution 1 |
| 306.57 | g | styrene |
| 286.67 | g | n-butyl acrylate |
| 113.34 | g | 2-ethylhexyl acrylate |
| 8.65 | g | acrylic acid |
| 5.77 | g | VTEO |
| 9.59 | g | sodium hydroxide (10 wt.-%) |

The solid content of the dispersion was 60.8%, 0.5 wt.-% of coagulum (dry on dispersion) had formed, and the pH was found to be 6.9. The aqueous polymer dispersion diluted with deionized water had a bimodal particle size distribution with populations at 106 nm (25 wt.-%) and 293 nm (75 wt.-%) and a viscosity of 417 mPas.

### Example 12

The reaction was conducted according to Example 10, with the exception that the following changes to feed 1 were made:

### Feed 1:

### Mixture X(2)

| | | |
|---|---|---|
| 179.10 | g | deionized water |
| 12.88 | g | emulsifier solution 1 |
| 306.57 | g | styrene |
| 286.67 | g | n-butyl acrylate |
| 113.34 | g | 2-ethylhexyl acrylate |
| 10.82 | g | methacrylic acid |
| 7.21 | g | AMPS |
| 10.09 | g | sodium hydroxide (10 wt.-%) |

The solid content of the dispersion was 60.6%, 0.2 wt.-% of coagulum (dry on dispersion) had formed, and the pH was found to be 6.8. The aqueous polymer dispersion diluted with deionized water had a bimodal particle size distribution with populations at 109 nm (27 wt.-%) and 295 nm (73 wt.-%) and a viscosity of 600 mPas.

### Example 13

The reaction was conducted according to Example 10, with the exception that the following changes to feed 1 were made:

### Feed 1:

### Mixture X(2)

| | | |
|---|---|---|
| 169.87 | g | deionized water |
| 12.88 | g | emulsifier solution 1 |
| 305.85 | g | styrene |
| 286.67 | g | n-butyl acrylate |
| 113.34 | g | 2-ethylhexyl acrylate |
| 8.65 | g | acrylic acid |
| 2.88 | g | MEMO |
| 7.21 | g | AMPS |
| 9.59 | g | sodium hydroxide (10 wt.-%) |

The solid content of the dispersion was 60.4%, 0.5 wt.-% of coagulum (dry on dispersion) had formed, and the pH was found to be 6.7. The aqueous polymer dispersion diluted with deionized water had a bimodal particle size distribution with populations at 98 nm (22 wt.-%) and 317 nm (78 wt.-%) and a viscosity of 709 mPas.

### Example 14

The reaction was conducted according to Example 10, with the exception that the following changes to feed 1 were made:

### Feed 1:

### Mixture X(2)

| | | |
|---|---|---|
| 179.10 | g | deionized water |
| 12.88 | g | emulsifier solution 1 |
| 300.80 | g | styrene |
| 286.67 | g | n-butyl acrylate |
| 113.34 | g | 2-ethylhexyl acrylate |
| 10.82 | g | methacrylic acid |
| 5.77 | g | VTEO |
| 7.21 | g | AMPS |
| 10.09 | g | sodium hydroxide (10 wt.-%) |

The solid content of the dispersion was 60.5%, 0.4 wt.-% of coagulum (dry on dispersion) had formed, and the pH was found to be 6.7. The aqueous polymer dispersion diluted with deionized water had a bimodal particle size distribution with populations at 120 nm (29 wt.-%) and 309 nm (71 wt.-%) and a viscosity of 526 mPas.

### Example 15

The reaction was conducted according to Example 8, with the exception that the following changes to feed 1 were made:

### Feed 1:

### Mixture X(2)

| | | |
|---|---|---|
| 149.81 | g | deionized water |
| 12.81 | g | emulsifier solution 1 |
| 307.23 | g | styrene |
| 285.28 | g | n-butyl acrylate |
| 112.79 | g | 2-ethylhexyl acrylate |
| 10.76 | g | methacrylic acid |
| 1.44 | g | MEMO |
| 50.23 | g | sodium hydroxide (10 wt.-%) |

The solid content of the dispersion was 62.0%, 0.2 wt.-% of coagulum (dry on dispersion) had formed, and the pH was found to be 6.9. The aqueous polymer dispersion diluted with deionized water had a bimodal particle size distribution with populations at 125 nm (34 wt.-%) and 304 nm (66 wt.-%) and a viscosity of 1340 mPas.

### Example 16

The reaction was conducted according to Example 9, with the exception that the following changes to feed 1 were made:

### Feed 1:

### Mixture X(2)

| | | |
|---|---|---|
| 154.05 | g | deionized water |
| 12.81 | g | emulsifier solution 1 |
| 310.82 | g | styrene |
| 285.28 | g | n-butyl acrylate |
| 112.79 | g | 2-ethylhexyl acrylate |
| 8.61 | g | acrylic acid |
| 9.59 | g | sodium hydroxide (10 wt.-%) |

The solid content of the dispersion was 62.3%, 0.2 wt.-% of coagulum (dry on dispersion) had formed, and the pH was found to be 7.1. The aqueous polymer dispersion diluted with deionized water had a bimodal particle size distribution with populations at 115 nm (29 wt.-%) and 309 nm (71 wt.-%) and a viscosity of 535 mPas.

### Example 17

The reaction was conducted according to Example 5, with the exception that the following changes to feed 1 were made:

### Feed 1:

### Mixture X(2)

| | | |
|---|---|---|
| 165.53 | g | deionized water |
| 12.81 | g | emulsifier solution 1 |
| 307.23 | g | styrene |
| 285.28 | g | n-butyl acrylate |
| 112.79 | g | 2-ethylhexyl acrylate |
| 10.76 | g | methacrylic acid |
| 1.44 | g | MEMO |
| 10.05 | g | sodium hydroxide (10 wt.-%) |

The solid content of the dispersion was 62.4%, 6.8 wt.-% of coagulum (dry on dispersion) had formed, and the pH was found to be 6.8. The aqueous polymer dispersion diluted with deionized water had a bimodal particle size distribution with populations at 115 nm (28 wt.-%) and 309 nm (72 wt.-%) and a viscosity of 620 mPas.

TABLE 1
Polymer dispersion properties, including solid content (SC),
size and weight fraction of the smaller particle species (d₁ and w₁),
size and weight fraction of the bigger particle species (d₂ and w₂),
viscosity (η), amount of coarse coagulum (CC, >125 μm), amount
of fine coagulum (FC, >10 μm), and film homogeneity grade (FH).

| | SC | d₁ | w₁ | d₂ | w₂ | η | CC | FC | |
|---|---|---|---|---|---|---|---|---|---|
| Sample | [%] | [nm] | [wt %] | [nm] | [wt %] | [mPas] | [wt %] | [μg/g] | FH |
| Ex. 1 | 61.6 | 122 | 26 | 305 | 74 | 544 | 0.3 | 200 | 2 |
| Ex. 2 | 62.6 | 113 | 17 | 314 | 83 | 844 | 0.3 | 600 | 2 |
| Ex. 3 | 60.6 | 58 | 21 | 232 | 79 | 310 | 0.1 | 2000 | 2 |
| Ex. 4 | 61.7 | 109 | 26 | 308 | 74 | 426 | 0.2 | 200 | 2 |
| Ex. 5 | 61.8 | 96 | 19 | 309 | 81 | 300 | 0.3 | 300 | 2 |
| Ex. 6 | 62.0 | 102 | 28 | 298 | 72 | 553 | 0.2 | 500 | 3 |
| Ex. 7 | 61.7 | 90 | 20 | 307 | 80 | 328 | 0.2 | 300 | 3 |
| Comp. 1 | 50.2 | 115 | 13 | 322 | 87 | — | 0.5 | 4500 | 2 |
| Comp. 2 | 59.6 | 127 | 13 | 370 | 87 | 120 | 1.1 | 9500 | 3 |
| Comp. 3 | 63.9 | 140 | 16 | 433 | 84 | 175 | 2.4 | 15000 | 4 |
| Comp. 4 | — | — | — | — | — | — | — | — | — |
| Ex. 8 | 61.3 | 110 | 23 | 305 | 77 | 440 | 0.3 | 200 | 2 |
| Ex. 9 | 62.2 | 101 | 18 | 327 | 82 | 344 | 0.2 | 300 | 2 |
| Ex. 10 | 60.8 | 106 | 26 | 298 | 74 | 375 | 0.4 | 1100 | 2 |
| Ex. 11 | 60.8 | 106 | 25 | 293 | 75 | 417 | 0.5 | 7300 | 3 |
| Ex. 12 | 60.6 | 109 | 27 | 295 | 73 | 600 | 0.2 | 1200 | 2 |
| Ex. 13 | 60.4 | 98 | 22 | 317 | 78 | 709 | 0.5 | 1000 | 2 |
| Ex. 14 | 60.5 | 120 | 29 | 309 | 71 | 526 | 0.4 | 1600 | 3 |
| Ex. 15 | 62.0 | 125 | 34 | 304 | 66 | 1340 | 0.2 | 200 | 2 |
| Ex. 16 | 62.3 | 115 | 29 | 309 | 71 | 535 | 0.2 | 2100 | 3 |
| Ex. 17 | 62.4 | 115 | 28 | 309 | 72 | 620 | 0.2 | 400 | 2 |

### Cited Literature

Chu et al., Study of Poly(St/BA/MAA) copolymer latexes with bimodal particle size distribution, Polym. Adv. Technol, 9, 851-857 (1998)
EP 1 302 515 A2
EP 3 452 523 B1
U.S. Pat. No. 5,726,259
WO 2023/203190-61
WO 1998/16560
WO 2001/38412
Tsavalas et al. Langmuir 2010, 26 (10), 6960-6966
Brandrup, J.; Immergut, E. H.; Grulke, E. A.; Polymer Handbook, 4th Edition, Wiley, New York, 1999
Kortum, Vogel, Andrussow; International Union of Pure and Applied Chemistry. Commission on Electrochemical Data, London, 1961
Brown, H. C. et al., in Braude, E. A. and F. C. Nachod; Determination of Organic Structures by Physical Methods, Academic Press, New York, 1955
Ullmann's Encyclopedia of Industrial Chemistry. 7th ed., Wiley-VCH, Weinheim, 2000, p. C-Crotonaldehyde and Crotonic Acid 4
Farbe und Lack, Die Modulare Lackfabrik im Kleinformat, December 2011, pages 14-17, Vincentz

1.-19. (canceled)

20. A process for preparing an aqueous polymer dispersion having a polymer content of at least 55 weight-% based on the total weight of the aqueous polymer dispersion, the process comprising
(i) preparing a first aqueous mixture X(1) comprising water, a seed latex and a first base, wherein the seed latex comprised in X(1) is an aqueous polymer dispersion having a polymer content in the range of from 20 to 50 weight-%, based on the total weight of the seed latex, wherein the polymer of the seed latex is polystyrene;
(ii) preparing a second aqueous mixture X(2) comprising water, ethylenically unsaturated monomers which exhibit a Bronsted acidic group, ethylenically unsaturated monomers which do not exhibit a Bronsted acidic group and a second base;
(iii) introducing the first aqueous mixture X(1) according to (i) into a polymerization vessel;
(iv) introducing the second aqueous mixture X(2) into the polymerization vessel comprising the first aqueous mixture X(1) according to (i) and subjecting to copolymerization, obtaining said aqueous polymer dispersion;
wherein the polymer particles of the aqueous polymer dispersion obtained according to (iv) exhibit a polymodal particle size distribution;
wherein at least 95 weight-% of the polymers comprised in the aqueous polymer dispersion are based on the monomers employed according to (ii) and (iv);
wherein said process further comprises
introducing a polystyrene seed latex at a time T(s) into the polymerization vessel, wherein T(s) starts when at least 5 weight-% of the aqueous mixture X(2) have been introduced into the polymerization vessel.

21. The process of claim 20, wherein the first base comprised in the first aqueous mixture X(1) comprises an anionic group and a counterion, the anionic group being selected from the group consisting of HCO₃⁻, P₂O₁⁴⁻, CH₃COO⁻, HPO₄²⁻, H₂PO₄⁻, C₃H₅O₃⁻, C₆H₅O₇³⁻ and CO₃²⁻.

22. The process of claim 20, wherein, in the first aqueous mixture X(1) prepared according to (i), the seed latex is an aqueous polymer dispersion having a polymer content in the range of from 25 to 42 weight-%, based on the total weight of the seed latex.

23. The process of claim 20, wherein (i) comprises
(i.1) admixing water and a first base under an inert gas atmosphere;
(i.2) admixing the seed latex to the mixture obtained according to (i.1);
(i.3) heating the mixture obtained according to (i.2) to a temperature in the range of from 70 to 100° C.

24. The process of claim 20, wherein the ethylenically unsaturated monomers which exhibit a Bronsted acidic group comprised in the second aqueous mixture X(2) prepared according to (ii) are selected from the group consisting of monoethylenically unsaturated monocarboxylic acids having 3 to 6 carbon atoms, monoethylenically unsaturated dicarboxylic acids having 4 to 6 carbon atoms, monoethylenically unsaturated sulfonic acids, monoethylenically unsaturated phosphonic acids, monoethylenically unsaturated phosphoric acids and a mixture of two or more thereof.

25. The process of claim 20, wherein the monomers which do not exhibit a Bronsted acidic group comprised in the second aqueous mixture prepared according to (ii) comprises one or more of C₁-C₂₀ alkyl esters of acrylic acid, C₁-C₂₀ alkyl esters of methacrylic acid, C₅-C₂₀ cycloalkyl esters of acrylic acid, C₅-C₂₀ cycloalkyl esters of methacrylic acid, C₅-C₂₀ cycloalkylmethyl esters of acrylic acid, C₅-C₂₀ cycloalkylmethyl esters of methacrylic acid, wherein the cycloalkyl in the aforementioned monomers is mono-, bi- or tricyclic and wherein 1 or 2 nonadjacent CH₂ moieties of the cycloalkyl may be replaced by oxygen atoms and wherein the cycloalkyl may be unsubstituted or carry 1, 2, 3 or 4 methyl groups, and vinylaromatic monomers.

26. The process of claim 20, wherein, in the second aqueous mixture X(2) prepared according to (ii), the degree of neutralization of the monomers which exhibit a Bronsted acidic group is in the range of from 5 to 250%.

27. The process of claim 20, wherein Tg(X(2)) is in the range of from −10 to 40° C., Tg(X(2)) being the theoretical glass transition temperature (Tg) of the polymer which would be obtained from polymerization of the monomers of the mixture X(2), wherein said theoretical glass transition temperatures Tg(X(2)) is determined according to the Fox equation.

28. The process of claim 20, wherein the second aqueous mixture X(2) further comprises monoethylenically unsaturated silane functional monomers.

29. The process of claim 20, wherein the second base comprised in the second aqueous mixture X(2) prepared according to (ii) is selected from the group consisting of sodium hydroxide, ammonium hydroxide, sodium carbonate, ammonium bicarbonate, potassium hydroxide, calcium hydroxide, sodium bicarbonate.

30. The process of claim 20, wherein according to (iv) the second aqueous mixture X(2) is introduced continuously into the polymerization vessel as a first feed.

31. The process of claim 30, wherein the first feed is introduced continuously at a constant feed rate; or
wherein the first feed is introduced into the polymerization vessel according to (iv) at different feed rates, F1-Fx, with x=2 or more, wherein F1<Fx, wherein the feed rates are >0 g/h.

32. The process of claim 20, wherein introducing the seed latex at a time T(s) comprises introducing the seed latex into the polymerization vessel, wherein T(s) starts when at least 10 weight-% of the aqueous mixture X(2) have been introduced into the polymerization vessel.

33. The process of claim 20, having an overall duration in the range of from 180 to 500 minutes.

34. The process of claim 20, the process comprising
(i) preparing a first aqueous mixture X(1) comprising water and a seed latex, wherein the seed latex is an aqueous polymer dispersion exhibiting a monomodal particle size distribution, the polymer particles of the seed latex having an average diameter in the range of from 10 to 100 nm, the weight-average particle diameter of the polymer latices being determined by hydrodynamic fractionation techniques (HDC).

35. An aqueous polymer dispersion obtainable or obtained by a process according to claim 20, said dispersion having a polymer content of at least 55 weight-%, based on the total weight of the aqueous polymer dispersion,
wherein the polymer particles of the aqueous polymer dispersion exhibit a polymodal particle size distribution such that X weight-% of the particles of the dispersion have a diameter in the range of from 40 to 150 nm, and Y weight-% of the particles of the dispersion have a diameter in the range of 180 to 400 nm, wherein Y=100-X, the weight-average particle diameter of the polymer latices being determined by hydrodynamic fractionation techniques (HDC).

36. Use of an aqueous polymer dispersion according to claim 35 in an aqueous formulation for coating, sealant and adhesive bonding.

37. An aqueous formulation for coatings, sealants and adhesive bonding, the aqueous formulation comprising an aqueous polymer dispersion according to claim 35, wherein the polymer content originating from the aqueous dispersion is in the range of from 5 to 90 weight-% based on the total weight of the aqueous formulation; wherein the aqueous formulation preferably further comprises at least one pigment and/or at least one filler.

38. The aqueous formulation of claim 37, being obtainable or obtained by a process comprising combining one or more slurries comprising the at least one pigment and/or the at least one filler with the aqueous polymer dispersion.
